(19) United States
(12) Patent Application Publication
(10) Pub. No.: US 2025/0287142 A1
(43) Pub. Date: Sep. 11, 2025

(54) Sound Generation Apparatus and Electronic Device

(71) Applicant: Huawei Technologies Co., Ltd., Shenzhen (CN)

(72) Inventors: Chunjian Li, Shanghai (CN); Jiayi Chen, Beijing (CN); Yujiang Ding, Shanghai (CN); Zhen Huang, Shanghai (CN); Chunjiao Pan, Beijing (CN); Chengbo Hu, Shanghai (CN)

(21) Appl. No.: 19/219,158

(22) Filed: May 27, 2025

Related U.S. Application Data
(63) Continuation of application No. PCT/CN2023/128776, filed on Oct. 31, 2023.

(30) Foreign Application Priority Data
Nov. 25, 2022 (CN) 202211492788.3
Mar. 31, 2023 (CN) 202310387490.4

(51) Int. Cl. H04R 1/28; H04R 1/02; H04R 1/34; H04R 3/04

(52) U.S. Cl. CPC H04R 1/2826; H04R 1/025; H04R 1/028; H04R 1/288; H04R 1/345; H04R 3/04; H04R 2499/11

(57) ABSTRACT

A sound generation apparatus comprises a transducer, a driving apparatus, and a control circuit. The driving apparatus is connected to the transducer. The control circuit is electrically connected to the transducer and the driving apparatus. The control circuit is configured to drive a vibration member of the transducer to vibrate, and the control circuit is further configured to control the driving apparatus to drive the transducer to perform periodic motion. The transducer is disposed to emit a first sound wave to the outside while performing periodic motion.

### CROSS-REFERENCE TO RELATED APPLICATIONS

This is a continuation of International Patent Application No. PCT/CN2023/128776 filed on Oct. 31, 2023, which claims priority to Chinese Patent Application No. 202211492788.3 filed on Nov. 25, 2022 and Chinese Patent Application No. 202310387490.4 filed on Mar. 31, 2023. All of the aforementioned patent applications are hereby incorporated by reference in their entireties.

### TECHNICAL FIELD

This application relates to the field of audio technologies, and in particular, to a sound generation apparatus and an electronic device.

### BACKGROUND

Microspeakers are widely used in many current consumer electronic products, providing audio entertainment and enhancing audio experience for a vast quantity of consumers.

In terms of physics teaching of sound wave propagation, in a human audible frequency range (usually 20 hertz (Hz) to 20 kilohertz (kHz)), sound pressure generated when another speaker drives a diaphragm to vibrate may be expressed as P=ρS_{d}/2πrA, where S_{d} is a surface area of the diaphragm, and A is acceleration of the diaphragm. That is, the sound pressure P is directly proportional to a product of the surface area S_{d} of the diaphragm and the acceleration A of the diaphragm. In addition, a relationship between displacement D of the diaphragm and the acceleration A of the diaphragm may be expressed as A=−w²D, where w is an angular frequency of a sound wave. An air push volume caused when the other speaker drives the diaphragm to vibrate is V=D* S_{d}. Therefore, the sound pressure may be rewritten as P=−ρω²/Pπr V. That is, the sound pressure is directly proportional to the air push volume V and directly proportional to a square of the angular frequency ω.

For example, in another electrodynamic speaker, a coil and a magnet are configured to generate a driving force for a diaphragm. A 1-kHz sound is generated when the diaphragm vibrates at 1 kHz over a specific surface area, and a 100-Hz sound is generated when the diaphragm vibrates at 100 Hz. If sound pressure levels (SPLs) at the two frequencies are the same, an air push volume required at 100 Hz is 100 times that required at 1 KHz. In other words, if the air push volumes at the two frequencies are the same, the sound pressure level at 100 Hz is 40 decibels (dB) less than that at 1 KHz.

In the other electrodynamic speaker, there is consistent displacement and a consistent air push volume for the diaphragm in a low frequency interval before a resonance frequency. Therefore, as an observation frequency is doubled, the sound pressure level is increased by 12 dB. In other words, as the observation frequency is halved, the sound pressure level is decreased by 12 dB. For example, if a sound pressure level of another speaker at 400 Hz is 90 dB under a test condition, a sound pressure level at 200 Hz is 78 dB under the same test condition. Therefore, the other speaker has a distinct low-frequency extension characteristic, a low-frequency roll-off reaches-12 dB, and a slope is large, resulting in an insufficient low-frequency sound pressure level of the speaker.

To increase the low-frequency sound pressure level of the speaker and improve audio experience, the displacement D of the diaphragm or the surface area A of the diaphragm needs to be increased. An increase in the surface area A of the diaphragm results in an increase in lateral space of the speaker, and an increase in the displacement D of the diaphragm results in an increase in longitudinal space of the speaker. Both the two manners require larger space of the speaker. Consequently, the speaker has an excessively large volume and cannot be stacked into an electronic product with a small volume. Therefore, how to increase the low-frequency sound pressure level of the speaker with a limited volume is an urgent problem to be resolved in the industry.

### SUMMARY

This application provides a sound generation apparatus and an electronic device in which the sound generation apparatus is used. The sound generation apparatus has a small volume, and a low-frequency sound pressure level of an audible sound that can be formed is high.

According to a first aspect, this application provides a sound generation apparatus. The sound generation apparatus includes a transducer, a driving apparatus, and a control circuit. The driving apparatus is connected to the transducer. The control circuit is electrically connected to the transducer and the driving apparatus. The control circuit is configured to drive a vibration member of the transducer to vibrate, and the control circuit is further configured to control the driving apparatus to drive the transducer to perform periodic motion.

It may be understood that the sound generation apparatus no longer uses another speaker structure, but instead the transducer is disposed to emit a first sound wave to the outside while performing periodic motion. In this case, a sound pressure amplitude at least one position in space changes, and the first sound wave is modulated to form a second sound wave. The second sound wave may include an audible sound.

In some implementations, the transducer may send an ultrasonic wave to the outside while performing periodic motion at a frequency greater than or equal to 20 kHz. In this case, because the ultrasonic wave has specific directivity, main lobe energy of the ultrasonic wave moves synchronously in a moving process, so that a sound wave amplitude at least one position in the space changes. In this way, the ultrasonic wave can be modulated in the space to form the second sound wave. The second sound wave may include an audible sound.

It may be understood that compared with another speaker that generates a sound at a same sound pressure level, vibration displacement of the vibration member of the transducer in this implementation is less than vibration displacement of a diaphragm of the other speaker.

It may be understood that the sound generation apparatus may obtain an audible sound at a high sound pressure level through small displacement vibration of the vibration member of the ultrasonic transducer. A low-frequency response of the sound generation apparatus has no or basically has no roll-off characteristic, a low-frequency roll-off of the sound generation apparatus is significantly less than 12 dB, and the sound generation apparatus can have a high low-frequency sound pressure level in a case of a small volume. The sound generation apparatus with a small volume has wider applicability in scenarios with space requirements. In addition, the sound generation apparatus may be used in a back cavity with a limited volume, and may still achieve strong low-frequency performance.

In addition, the audible sound formed by modulating the first sound wave may have sound wave directivity. Therefore, the sound generation apparatus may be suitable for some private scenarios. The sound generation apparatus may play a sound in a specific direction or toward a specific user. For example, in a private call scenario, when a user makes a call and does not want another person to hear a downlink sound of the call, the sound has directivity, so that the sound is emitted only toward the user and cannot be heard by a surrounding person. For another example, in a music exclusive scenario, when another person rests around and a user wants to enjoy audio and video entertainment, the sound has directivity, so that the sound is emitted only toward the user and cannot be heard by a surrounding person, so as not to disturb the surrounding person.

In a possible implementation, the control circuit controls the driving apparatus to drive the transducer to perform continuous rotation, reciprocating rotation, or reciprocating translational motion.

It may be understood that the transducer may emit a first sound wave to the outside while performing continuous rotation, reciprocating rotation, or reciprocating translational motion. In this case, a sound pressure amplitude at least one position in space changes, and the first sound wave is modulated to form a second sound wave. The second sound wave may include an audible sound. A frequency of the audible sound may be less than a frequency of the first sound wave.

In some implementations, the transducer may send an ultrasonic wave to the outside while performing continuous rotation, reciprocating rotation, or reciprocating translational motion at a frequency greater than or equal to 20 kHz. In this case, because the ultrasonic wave has specific directivity, main lobe energy of the ultrasonic wave moves synchronously in a moving process, so that a sound wave amplitude at least one position in the space changes. In this way, the ultrasonic wave can be modulated in the space to form the second sound wave. The second sound wave may include an audible sound.

In a possible implementation, when the control circuit controls the driving apparatus to drive the transducer to perform continuous rotation or reciprocating rotation, a rotating shaft of the transducer is parallel to a plane on which the transducer is located, or a rotating shaft of the transducer intersects with the transducer, or a rotating shaft of the transducer is perpendicular to the transducer, and the rotating shaft of the transducer deviates from a center of the transducer. In this way, the transducer may emit a first sound wave to the outside while performing continuous rotation, reciprocating rotation, or reciprocating translational motion. In this case, a sound pressure amplitude at least one position in space may change.

In a possible implementation, the sound generation apparatus further includes a base, and the transducer is disposed on the base; and the driving apparatus includes a first cantilever and a second cantilever, a movable end of the first cantilever is connected to a first side of the base, and a movable end of the second cantilever is connected to a second side of the base; and the control circuit is configured to drive the movable end of the first cantilever and the movable end of the second cantilever to perform reciprocating vibration, and in a same time period, vibration directions of the movable end of the first cantilever and the movable end of the second cantilever are opposite.

It may be understood that the movable end of the first cantilever drives the first side of the base to perform reciprocating vibration, the movable end of the second cantilever drives the second side of the base to perform reciprocating vibration, and in the same time period, the vibration directions of the movable end of the first cantilever and the movable end of the second cantilever are opposite, so that the base can perform periodic motion of reciprocating rotation around a virtual rotating shaft.

It may be understood that the movable end of the first cantilever drives the first side of the base to perform reciprocating vibration, and the movable end of the second cantilever drives the second side of the base to perform reciprocating vibration, so that the base can perform reciprocating rotation at a high frequency.

In a possible implementation, a rotation angle of the base is θ, and θ satisfies: −45 degrees) (°)≤θ≤45°.

It may be understood that when the base drives the transducer to rotate within −45°≤θ≤45°, it can be ensured that the audible sound generated by the sound generation apparatus has good linearity and very high energy.

In a possible implementation, the sound generation apparatus further includes a base, and the transducer is disposed on the base; and the driving apparatus includes a first motor, and a first output shaft of the first motor is connected to the base, and is configured to drive the base to perform reciprocating rotation or continuous rotation.

In a possible implementation, there are a plurality of transducers, and the plurality of transducers are arranged on the base at an interval in a rotation direction.

It may be understood that the first sound wave jointly emitted by the plurality of transducers has a plurality of side lobes or a plurality of beams. In this way, a requirement for a rotation frequency can be greatly lowered. For example, if there are n transducers and n side lobes, an equivalent rotation frequency of the n side lobes in a rotation process is n×f. Therefore, the n side lobes can reduce the rotation frequency to f₂/n.

In a possible implementation, the sound generation apparatus further includes a base, and the transducer is disposed on the base; and the driving apparatus includes a telescopic arm, the telescopic arm is connected to the base, and the telescopic arm extends and retracts to drive the base to perform reciprocating translational motion.

It may be understood that the telescopic arm extends and retracts to drive the base to perform reciprocating translational motion, so that the base can perform a reciprocating translational motion at a high frequency.

In a possible implementation, the control circuit is configured to generate a first control signal and a second control signal, the first control signal is configured to drive the vibration member of the transducer to vibrate to generate a first sound wave, and the second control signal is configured to control the driving apparatus to drive the transducer to perform periodic motion to modulate the first sound wave, to form a second sound wave.

In a possible implementation, a frequency of the first control signal includes a first frequency f₁, and the first frequency f₁ is a single frequency or a wide band; and a frequency of the second control signal includes a second frequency f₂, and the second frequency f₂ is a single frequency or a wide band.

It may be understood that the transducer is disposed to emit the first sound wave at the first frequency of f₁ to the outside while performing periodic motion at the second frequency of f₂. In this case, in a process of periodic motion of the transducer, a sound pressure amplitude received at least one position in the space changes, and in this case, the first sound wave is modulated to form the second sound wave. The second sound wave may include sound waves at two frequencies, and the frequencies of the sound waves are respectively |f₁+f₂| and |f₁−f₂|. In this way, values of the first frequency f₁ and the second frequency f₂ may be set, so that a frequency of one sound wave in the second sound wave falls within a range of an ultrasonic wave, and a frequency of the other sound wave falls within a frequency range of an audible sound. Because the ultrasonic wave may be automatically filtered out by a human ear, the user may hear one sound wave in the space, and the sound wave is an audible sound.

In a possible implementation, at least a part of the second sound wave includes an audible sound, and the first frequency f₁ and the second frequency f₂ satisfy: 20 Hz≤|f₁−f₂|≤20 kHz. In this way, the second sound wave from the sound generation apparatus includes an audible sound, that is, the sound generation apparatus can emit an audible sound.

In a possible implementation, a frequency of the second sound wave includes |f₁−f₂| and |f₁+f₂|.

In a possible implementation, the first frequency f₁ and the second frequency f₂ further satisfy: f₁≥20 kHz and f₂≥20 KHz.

It may be understood that both f₁ and f₂ are set to ultrasonic wave frequencies, to ensure that |f₁+f₂| can definitely fall within an ultrasonic wave range, and ensure that a sound wave at the frequency of |f₁+f₂| in the space cannot be heard by a human.

In addition, because f₁≥20 kHz, the transducer may send an ultrasonic wave to the outside. Because the ultrasonic wave has specific directivity, main lobe energy of the ultrasonic wave moves synchronously in a moving process, so that a sound wave amplitude at least one position in the space changes. In this way, the ultrasonic wave can be modulated in the space to form the second sound wave. The second sound wave may include an audible sound. In this way, the sound generation apparatus may obtain an audible sound at a high sound pressure level through small displacement vibration of the vibration member of the transducer. A low-frequency response of the sound generation apparatus has no or basically has no roll-off characteristic, a low-frequency roll-off of the sound generation apparatus is significantly less than 12 dB, and the sound generation apparatus can have a high low-frequency sound pressure level in a case of a small volume. The sound generation apparatus with a small volume has wider applicability in scenarios with space requirements. In addition, the sound generation apparatus may be used in a back cavity with a limited volume, and may still achieve strong low-frequency performance.

In addition, the audible sound formed by modulating the first sound wave with directivity has sound wave directivity. Therefore, the sound generation apparatus may be suitable for some private scenarios. The sound generation apparatus may play a sound in a specific direction or toward a specific user. For example, in a private call scenario, when a user makes a call and does not want another person to hear a downlink sound of the call, the sound has directivity, so that the sound is emitted only toward the user and cannot be heard by a surrounding person. For another example, in a music exclusive scenario, when another person rests around and a user wants to enjoy audio and video entertainment, the sound has directivity, so that the sound is emitted only toward the user and cannot be heard by a surrounding person, so as not to disturb the surrounding person.

In a possible implementation, the first frequency f₁ and the second frequency f₂ further satisfy: |f₁+f₂|≥20 KHz.

It may be understood that the second sound wave may include sound waves at two frequencies, and the frequencies of the sound waves are respectively |f₁+f₂| and |f₁−f₂l. The first frequency f₁ and the second frequency f₂ are set to further satisfy |f₁+f₂|≥20 kHz, so that a sound wave at the frequency of |f₁+f₂| can fall within a frequency range of an ultrasonic wave. In this way, the sound wave at the frequency of |f₁+f₂| in the space cannot be heard by a human.

In a possible implementation, a vibration frequency of the vibration member of the transducer includes the first frequency f₁, and the first frequency f₁ is a single frequency or a wide band; and a motion frequency of the transducer includes the second frequency f₂, and the second frequency f₂ is a single frequency or a wide band.

It may be understood that the transducer is disposed to emit the first sound wave at the first frequency of f₁ to the outside while performing periodic motion at the second frequency of f₂. In this case, in a process of periodic motion of the transducer, a sound pressure amplitude received at least one position in the space changes, and in this case, the first sound wave is modulated to form the second sound wave. The second sound wave may include sound waves at two frequencies, and the frequencies of the sound waves are respectively |f₁+f₂| and |f₁−f₂|. In this way, values of the first frequency f₁ and the second frequency f₂ may be set, so that a frequency of one sound wave in the second sound wave falls within a range of an ultrasonic wave, and a frequency of the other sound wave falls within a frequency range of an audible sound. Because the ultrasonic wave may be automatically filtered out by a human ear, the user may hear one sound wave in the space, and the sound wave is an audible sound.

In a possible implementation, at least a part of the second sound wave includes an audible sound, and the first frequency f₁ and the second frequency f₂ satisfy: 20 Hz≤ |f₁−f₂|≤20 kHz. In this way, the second sound wave from the sound generation apparatus includes an audible sound, that is, the sound generation apparatus can emit an audible sound.

In a possible implementation, the frequency of the second sound wave includes |f₁−f₂| and |f₁+f₂|.

In a possible implementation, the sound generation apparatus further includes a casing, the casing is provided with a sound outlet hole, the sound outlet hole communicates with an inner cavity and external space of the casing, both the transducer and the driving apparatus are disposed in the inner cavity of the casing, and the control circuit is disposed in the inner cavity or the external space of the casing.

It may be understood that the casing may be configured to provide isolation from, a connection to, and fastening to another part of an electronic device. In addition, the transducer and the driving apparatus are packaged into an integral structure through the casing, to achieve good integrity of the sound generation apparatus. This facilitates adaptation to application of the sound generation apparatus to an integrated machine, that is, facilitates arrangement of the sound generation apparatus in the electronic device.

In a possible implementation, an included angle between an axial direction of the vibration member of the transducer and an extension direction of the sound outlet hole is a; and a satisfies: 45°≤a≤135°.

It may be understood that a is set to satisfy 45°% a≤135°, so that a direction at a higher sound pressure level in the audible sound faces the sound outlet hole of the casing. In this case, a sound pressure level of an audible sound transmitted out of the casing is higher.

In a possible implementation, the sound generation apparatus further includes a sound-absorbing part, and the sound-absorbing part is disposed on an inner surface of the casing and disposed in a staggered manner with the sound outlet hole.

It may be understood that the sound-absorbing part is disposed on the inner surface of the casing, and the sound-absorbing part may absorb a sound wave propagated to the inner surface of the casing, to reduce reflection of the sound wave in the casing and reduce distortion of an audible sound.

In a possible implementation, the casing is provided with a sound wave guiding structure, the sound wave guiding structure is disposed at an interval from the sound outlet hole, and the sound wave guiding structure communicates the inner cavity of the casing with the external space of the casing.

It may be understood that the sound wave guiding structure may be configured to export a sound wave in the inner cavity of the casing to the external space of the casing. In this way, the sound wave guiding structure may be configured to implement atmospheric pressure balance between the inner cavity of the casing and the outside of the casing, so that the transducer can smoothly vibrate, and a sound wave with a small distortion degree is formed under driving of the first control signal.

In a possible implementation, the sound wave guiding structure is a hole structure and/or a pipe structure; and a minimum width of the sound wave guiding structure is greater than a thickness d_{μ} of a viscous layer, and the thickness d_{μ} of the viscous layer satisfies:

$${d}_{μ} = 0.22 mm \times \sqrt{\frac{100 Hz}{{f}_{1}}} ,$$

where f₁ is a frequency of the first sound wave.

In a possible implementation, the sound generation apparatus further includes an adjustment mechanism, the adjustment mechanism has a first sound output hole, and a size of the first sound output hole is capable of becoming larger or smaller; and the adjustment mechanism is disposed on the casing, and the first sound output hole of the adjustment mechanism communicates with the sound outlet hole of the casing.

It may be understood that when the size of the first sound output hole of the adjustment mechanism becomes larger, an area of a channel in which the audible sound is conducted is large. In this way, the audible sound is not prone to diffraction at the first sound output hole. Therefore, directivity of the audible sound conducted to the casing is not prone to change. When the size of the first sound output hole of the adjustment mechanism becomes smaller, an area of a channel in which the audible sound is conducted is small. In this way, the audible sound is prone to diffraction at the first sound output hole. Therefore, directivity of the audible sound conducted to the casing is prone to change.

It may be understood that when low-frequency directivity is required, an area of the first sound output hole is increased. A suitable scenario herein may be that the sound generation apparatus plays a sound in a specific direction or toward a specific user. For example, in a private call scenario, when a user makes a call and does not want another person to hear a downlink sound of the call, an aperture of the first sound output hole is adjusted to be larger, and the sound has directivity, so that the sound is emitted only toward the user and cannot be heard by a surrounding person. For another example, in a music exclusive scenario, when another person rests around and a user wants to enjoy audio and video entertainment, an aperture of the first sound output hole is adjusted to be larger, and the sound has directivity, so that the sound is emitted only toward the user and cannot be heard by a surrounding person, so as not to disturb the surrounding person.

When low-frequency directivity is not required, an area of the first sound output hole is decreased. A suitable scenario herein may be that the sound generation apparatus plays a sound toward users in a plurality of directions. For example, when people around a user want to listen to the sound together, the first sound output hole may be adjusted to be smaller, and the audible sound has no directivity, so that all people around the user can hear the sound.

In a possible implementation, the sound generation apparatus further includes a front cavity filter, the front cavity filter is fastened to the casing, and a second sound output hole of the front cavity filter communicates with the sound outlet hole of the casing; and a hole wall of the second sound output hole is of a variable cross-sectional structure, or the second sound output hole has a Helmholtz resonator.

It may be understood that the sound generation apparatus may generate at least two sound wave frequencies, for example, |f₁+f₂| and |f₁−f₂|. An undesired sound wave frequency in the space may be filtered out through the front cavity filter, to leave a sound wave at one frequency. For example, a sound wave at the frequency of |f₁+f₂| may be filtered out, to retain a sound wave at |f₁−f₂|; or a sound wave at the frequency of |f₁−f₂| may be filtered out, to retain a sound wave at |f₁+f₂l.

In a possible implementation, a phase q(r) of the first sound wave transmitted by the vibration member of the transducer satisfies:

$$φ ( r ) = \frac{2 π * ( \sqrt{{f}^{2} + {r}^{2}} - f )}{λ}$$

Herein, r is a distance between any point on the vibration member and a center of the vibration member, Δ is a wavelength corresponding to the first sound wave emitted by the vibration member, and f is a focal length corresponding to the first sound wave emitted by the vibration member.

It may be understood that when the phase q(r) of the sound wave emitted by the vibration member satisfies the foregoing relational expression, the phase of the sound wave emitted by the vibration member may be focused, to enhance directivity of the sound wave emitted by the vibration member and increase a sound pressure level of the audible sound.

In a possible implementation, the transducer may further include a sound wave directing member, and the sound wave directing member is disposed on the vibration member of the transducer; and an emission surface of the sound wave directing member is in a conical shape.

It may be understood that the sound wave directing member is configured to limit a radiation direction of the first sound wave generated by the transducer, to enhance the directivity of the sound wave emitted by a diaphragm and increase the sound pressure level of the audible sound. In addition, the conical emission surface can narrow the directivity of the first sound wave to approximately 60°, to greatly enhance the directivity of the sound wave emitted by the diaphragm.

In a possible implementation, the base is provided with accommodation space, and at least a part of the transducer is located in the accommodation space.

It may be understood that there is an overlapping region between the transducer and the base in a thickness direction, to facilitate thinning of the sound generation apparatus in the thickness direction.

In a possible implementation, the base is a part of the transducer, and the base is provided with accommodation space; and the vibration member of the transducer is connected to a wall surface of the accommodation space through a connecting piece.

It may be understood that the vibration member of the transducer is connected to the wall surface of the accommodation space through the connecting piece, so that the transducer may not include a support member. In this way, the transducer and the base may form an integral structure. The transducer can save a structure of the support member, so that the transducer and the base are arranged more compactly and the sound generation apparatus has a simpler structure.

According to a second aspect, this application provides an electronic device. The electronic device includes the sound generation apparatus described above. The electronic device may emit an audible sound, and the audible sound has a high sound pressure level.

### BRIEF DESCRIPTION OF DRAWINGS

FIG. 1 is a diagram of a partial structure of an electronic device according to an embodiment of this application;

FIG. 2 is a block diagram of a sound generation apparatus in some embodiments according to an embodiment of this application;

FIG. 3 is a diagram of a structure of a sound generation component of the sound generation apparatus shown in FIG. 2 in an implementation;

FIG. 4 is a diagram of a structure of a transducer shown in FIG. 3 in an implementation;

FIG. 5 is a diagram of a sound wave emitted by the transducer shown in FIG. 4 in an implementation;

FIG. 6 is a first diagram of a sound generation principle of the sound generation apparatus shown in FIG. 3;

FIG. 7 is a diagram of energy distribution of a sound wave emitted by the sound generation apparatus shown in FIG. 3 and energy distribution of a main lobe of a first sound wave emitted by a transducer;

FIG. 8 is a diagram of a structure of a sound generation component of the sound generation apparatus shown in FIG. 2 in another implementation;

FIG. 9 is a diagram of a structure of a sound generation component of the sound generation apparatus shown in FIG. 2 in still another implementation;

FIG. 10 is a diagram of a structure of a sound generation component of the sound generation apparatus shown in FIG. 2 in still another implementation;

FIG. 11A is a diagram of a structure of a sound generation component of the sound generation apparatus shown in FIG. 2 in still another implementation;

FIG. 11B is a diagram of a structure of a sound generation component of the sound generation apparatus shown in FIG. 2 in still another implementation;

FIG. 12 is a diagram of a structure of a sound generation component of the sound generation apparatus shown in FIG. 2 in still another implementation;

FIG. 13A is a partial cross-sectional view of an implementation of the sound generation component shown in FIG. 12 along a line A-A;

FIG. 13B is a partial cross-sectional view of another implementation of the sound generation component shown in FIG. 12 along a line A-A;

FIG. 14 is a diagram of a structure of a sound generation component of the sound generation apparatus shown in FIG. 2 in still another implementation;

FIG. 15 is a diagram of a structure of a sound generation component of the sound generation apparatus shown in FIG. 2 in still another implementation;

FIG. 16 is a partial cross-sectional view of an implementation of the sound generation component shown in FIG. 15 along a line B-B;

FIG. 17 is a diagram of a structure of a sound generation component of the sound generation apparatus shown in FIG. 2 in still another implementation;

FIG. 18 is a diagram of a structure of a sound generation component of the sound generation apparatus shown in FIG. 2 in still another implementation;

FIG. 19 is a partial cross-sectional view of an implementation of the sound generation component shown in FIG. 18 along a line C-C;

FIG. 20 is a diagram of a structure of an ultrasonic transducer in some embodiments according to an embodiment of this application;

FIG. 21 is a schematic cross-sectional view of a sound generation component of the sound generation apparatus shown in FIG. 2 in still another implementation;

FIG. 22 is a schematic cross-sectional view of a sound generation component of the sound generation apparatus shown in FIG. 2 in still another implementation;

FIG. 23 is a diagram of a structure of a sound generation component of the sound generation apparatus shown in FIG. 2 in still another implementation;

FIG. 24 is a diagram of energy distribution of a main lobe of a first sound wave emitted by a plurality of transducers shown in FIG. 23;

FIG. 25 is a diagram of a structure of a sound generation component of the sound generation apparatus shown in FIG. 2 in still another implementation; and

FIG. 26 is a diagram of a structure of a sound generation component of the sound generation apparatus shown in FIG. 2 in still another implementation.

### DESCRIPTION OF EMBODIMENTS

The following describes technical solutions of embodiments of this application with reference to accompanying drawings. In the descriptions of embodiments of this application, unless otherwise specified, “/” represents “or”. For example, A/B may represent A or B. In this specification, “and/or” is merely an association relationship for describing associated objects, and represents that three relationships may exist. For example, A and/or B may represent the following three cases: Only A exists, both A and B exist, and only B exists. In addition, in the descriptions of embodiments of this application, “a plurality of” means two or more.

In the following, terms such as “first” and “second” are used only for description purposes, and cannot be understood as an indication or implication of relative importance or an implicit indication of a quantity of indicated technical features. Therefore, a feature limited by “first” or “second” may explicitly or implicitly include one or more features.

The orientation terms such as “upper”, “lower”, “inner”, “outer”, “side”, “top”, and “bottom” in embodiments of this application are merely directions described with reference to the accompanying drawings. Therefore, the orientation terms are used to better and more clearly describe and understand embodiments of this application, instead of indicating or implying that a specified apparatus or element needs to have a specific orientation, or be constructed and operated in a specific orientation. Therefore, this cannot be understood as a limitation on embodiments of this application.

In the descriptions of embodiments of this application, it should be noted that unless otherwise explicitly specified and limited, the terms “mounted”, “connected”, “connection”, and “disposed on . . . ” should be understood in a broad sense. For example, a “connection” may be a detachable connection, a non-detachable connection, a direct connection, or an indirect connection implemented through an intermediate medium. A “fixed connection” may mean that parts are connected to each other and a relative position relationship remains unchanged after the parts are connected. A “rotatable connection” may mean that parts are connected to each other and can rotate relative to each other after being connected. A “slidable connection” may mean that parts are connected to each other and can slide relative to each other after being connected. An “electrical connection” means that an electrical signal may be conducted between each other.

Embodiments of this application provide a sound generation apparatus and an electronic device in which the sound generation apparatus is used. The sound generation apparatus uses a sound generation method different from that of another speaker. The sound generation apparatus emits a first sound wave at a first frequency of f₁ to space while performing periodic motion at a second frequency of f₂ through a transducer, and the first sound wave is modulated in the space, to form a second sound wave. The first frequency f₁ may be a single frequency or a wide band. The second frequency f₂ may be a single frequency or a wide band. In addition, the second sound wave may include an audible sound, and a frequency of the audible sound may be less than a vibration frequency of the transducer of the sound generation apparatus. The sound generation apparatus in this application may have a high low-frequency sound pressure level while having a small volume. In addition, the audible sound emitted by the sound generation apparatus has sound directivity, which can satisfy some requirements for private calls, thereby greatly improving user experience. The electronic device may be an electronic device that needs to output audio through the sound generation apparatus, for example, a mobile phone, a tablet, a hearing aid, or a smart wearable device. The smart wearable device may be a smartwatch, augmented reality (AR) glasses, an AR helmet, virtual reality (VR) glasses, or the like. The sound generation apparatus may alternatively be a device that can output an audible sound, for example, a headset or a player. In addition, the sound generation apparatus may be further applied to fields such as a whole house, a smart home, and a vehicle, and is used as an audio device or a part of an audio device.

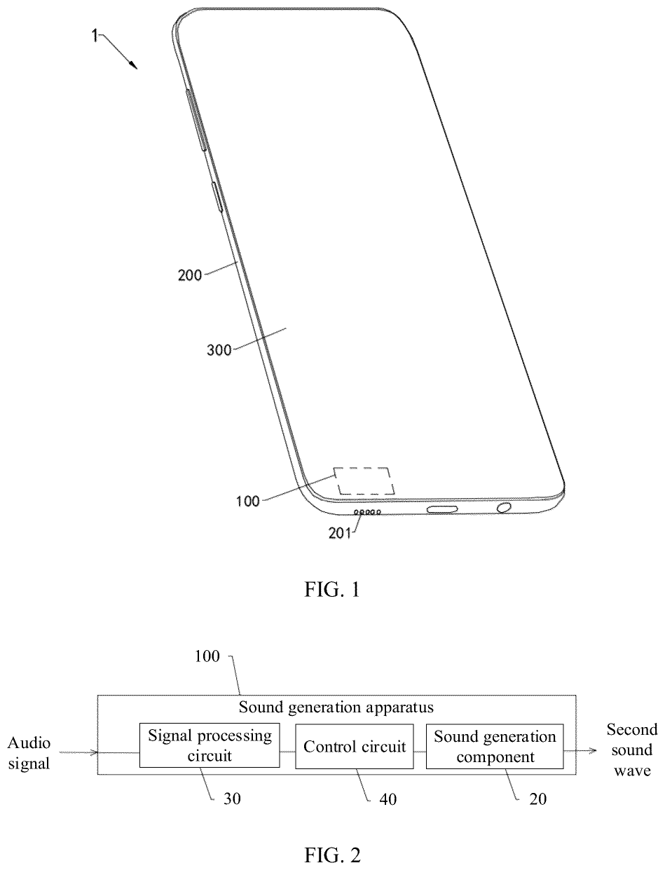

FIG. 1 is a diagram of a partial structure of an electronic device 1 according to an embodiment of this application. In the embodiment shown in FIG. 1, an example in which the electronic device 1 is a mobile phone is used for description.

As shown in FIG. 1, the electronic device 1 includes a sound generation apparatus 100, a housing 200, and a screen 300. Because the sound generation apparatus 100 is an internal component of the electronic device 1, FIG. 1 schematically shows the sound generation apparatus 100 through a dashed line. It may be understood that FIG. 1 and the following related accompanying drawings merely schematically show some parts included in the electronic device 1000. Actual shapes, actual sizes, actual positions, and actual structures of these parts are not limited by FIG. 1 and the following accompanying drawings. In addition, when the electronic device 1000 is a device in another form, the electronic device 1000 may not include the housing 200 and the screen 300.

The screen 300 is mounted on the housing 200. The screen 300 and the housing 200 may enclose an inner cavity of the electronic device 1. The sound generation apparatus 100 may be mounted in the inner cavity of the electronic device 1. The housing 200 has a sound outlet 201. The sound outlet 201 communicates with the inner cavity of the electronic device 1 and external space of the electronic device 1. In this case, a sound emitted by the sound generation apparatus 100 may be transmitted out of the electronic device 1 through the sound outlet 201. It may be understood that a shape of the sound outlet 201 is not limited to a cylindrical hole shown in FIG. 1. The shape of the sound outlet 201 may alternatively be a special-shaped hole. The sound outlet 201 is not limited to five outlets shown in FIG. 1.

FIG. 2 is a block diagram of a sound generation apparatus 100 in some embodiments according to an embodiment of this application.

With reference to FIG. 2, the sound generation apparatus 100 may include a sound generation component 20 (also referred to as a sound generation unit, a sound generation module, or the like), a signal processing circuit 30, and a control circuit 40. In another implementation, the sound generation apparatus 100 may further include more or fewer parts. For example, in some embodiments, the sound generation apparatus 100 may further include a casing configured to place the sound generation component 20, the signal processing circuit 30, and the control circuit 40. In this way, the sound generation component 20, the signal processing circuit 30, and the control circuit 40 may be protected through the casing. For another example, in some embodiments, the sound generation apparatus 100 may further include at least one of a micro-electro-mechanical system (MEMS) speaker, a moving iron speaker, and a moving coil speaker. In this case, the sound generation apparatus 100 may have functions of a plurality of sound generation units. In this case, the sound generation apparatus 100 may assume sound generation on a specific frequency band. In another embodiment, the sound generation apparatus 100 may serve as an independent unit to generate a sound and assume full-band sound generation.

In an implementation, the signal processing circuit 30 is configured to convert an audio signal into an electrical signal. The signal processing circuit 30 may include a chip and a related link configured to perform signal processing, for example, a system on chip (SoC) or a central processing unit (CPU). The audio signal may be output by a sound source. The audio signal may be a digital signal or an analog signal. When the audio signal is an analog signal, the audio signal may be converted into a digital signal by an analog-to-digital conversion circuit. The analog-to-digital conversion circuit may be a part of the signal processing circuit 30, or may be another circuit independent of the signal processing circuit 30. This is not strictly limited in this embodiment of this application.

In addition, the control circuit 40 is electrically connected to the sound generation component 20 and the signal processing circuit 30. The control circuit 40 may include a circuit structure such as a power amplification chip and a related link. In addition, the control circuit 40 may be configured to form a control signal based on an electrical signal, and send the control signal to the sound generation component 20. The control signal may have information such as a preset voltage and preset power. The sound generation component 20 is configured to emit a first sound wave based on the control signal. The first sound wave is modulated in space to form a second sound wave. The second sound wave may include an audible sound (a frequency of the audible sound falls within a range of 20 Hz to 20 kHz). A principle of modulating the first sound wave to form an audible sound is described in detail below with reference to related accompanying drawings. Details are not described herein again.

It may be understood that the sound generation apparatus 100 may be a modular component, and the signal processing circuit 30 and the control circuit 40 of the sound generation apparatus 100 may be integrated into a circuit assembly of the sound generation apparatus 100. The circuit assembly usually may include one or more circuit boards, one or more chips, and matching elements thereof. Alternatively, in some embodiments, when the sound generation apparatus 100 is used in an electronic device, the signal processing circuit 30 and/or the control circuit 40 of the sound generation apparatus 100 may alternatively be fastened to or integrated into another part of the electronic device. This is not strictly limited in this embodiment of this application.

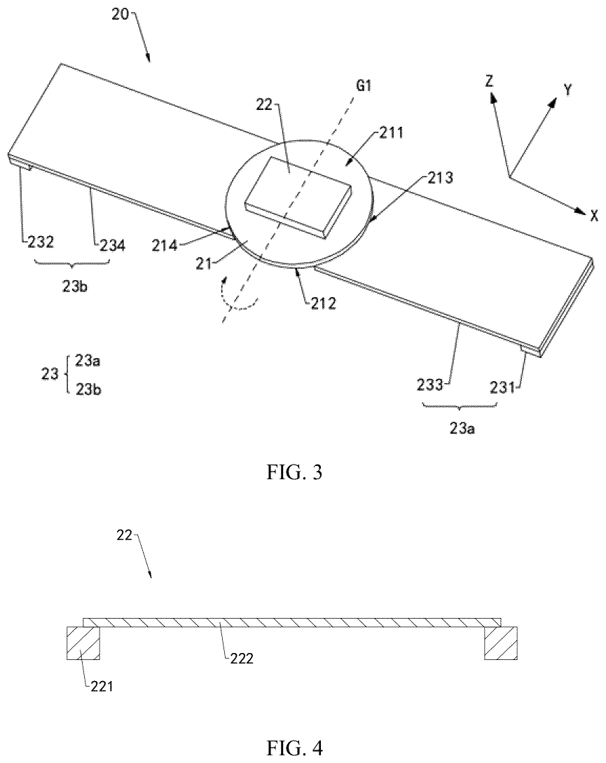

FIG. 3 is a diagram of a structure of the sound generation component 20 of the sound generation apparatus 100 shown in FIG. 2 in an implementation.

As shown in FIG. 3, the sound generation component 20 of the sound generation apparatus 100 includes a base 21, a transducer 22, and a driving apparatus 23.

The base 21 may be a platform structure. The base 21 includes a first surface 211 and a second surface 212 that are disposed facing away from each other, that is, the first surface 211 and the second surface 212 are disposed back to back. Both the first surface 211 and the second surface 212 may be planar. In addition, a shape of the base 21 is not limited to a disc structure shown in FIG. 3. It may be understood that a specific structure of the base 21 is not specifically limited in this application.

FIG. 4 is a diagram of a structure of the transducer 22 shown in FIG. 3 in an implementation.

With reference to FIG. 4 and with reference to FIG. 3, the transducer 22 includes a vibration member 222 and a support member 221. The vibration member 222 is fastened to the support member 221. The vibration member 222 is configured to reciprocally vibrate under driving of the control signal, to form the first sound wave. The first sound wave may be an ultrasonic wave (a sound wave at a frequency greater than 20 kHz). Alternatively, the first sound wave may be a sound wave of an audible sound or a sound wave on another frequency band. When the first sound wave is an ultrasonic wave, the transducer 22 may be referred to as an ultrasonic transducer. The first sound wave may alternatively be a sound wave of an audible sound. In this case, the transducer 22 may be referred to as an audible sound transducer.

It may be understood that the transducer 22 may use a piezoelectrically driven vibration member, or may use a magnetoelectrically driven vibration member. In addition, the transducer may be a transducer manufactured by using a MEMS process, or may be a transducer of another structure (for example, a moving coil transducer or a moving iron transducer). A structure of the transducer 22 is not specifically limited in this application.

As shown in FIG. 3 and FIG. 4, the transducer 22 is fastened to the base 21. For example, the support member 221 of the transducer 22 may be fixedly connected to the first surface 211 of the base 21 by using adhesive or in another manner. The first sound wave emitted by the transducer 22 may be emitted through a side on which the first surface 211 is located.

In another implementation, when the transducer 22 is of another structure, the transducer 22 and the base 21 may alternatively be connected in another manner.

As shown in FIG. 3, the driving apparatus 23 may be a vibrating driving apparatus, may be a rotating driving apparatus, or may be a translational driving apparatus. It may be understood that the vibrating driving apparatus may mean that a cantilever of the driving apparatus reciprocally vibrates up and down. The rotating driving apparatus may mean that an output shaft of the driving apparatus may reciprocally rotate at a specific angle, or may continuously rotate at 360°. The translational driving apparatus may mean that the driving apparatus reciprocally moves in one direction.

In addition, the driving apparatus 23 may be a driving apparatus with a piezoelectric driving force, a driving apparatus with an electromagnetic driving force, a driving apparatus with an electrostatic driving force, or a driving apparatus with a magnetostrictive driving force. It may be understood that a structure of the driving apparatus 23 is not specifically limited in this application.

The following describes several specific structures of the driving apparatus 23 with reference to related accompanying drawings.

In an implementation, the driving apparatus 23 may be a driving apparatus 23 with a piezoelectric driving force. Further, the driving apparatus 23 includes a first piezoelectric driving mechanism 23a and a second piezoelectric driving mechanism 23b.

The first piezoelectric driving mechanism 23a includes a first fixed base 231 and a first cantilever 233. A first end of the first cantilever 233 is fixedly connected to the first fixed base 231. A second end of the first cantilever 233 extends relative to the first fixed base 231. It may be understood that the first end of the first cantilever 233 is a fixed end relative to the first fixed base 231. The second end of the first cantilever 233 is a movable end relative to the first fixed base 231. For example, the first cantilever 233 includes a piezoelectric sheet (not shown in the figure). When the piezoelectric sheet is energized, the piezoelectric sheet may be deformed, and the second end of the first cantilever 233 may reciprocally vibrate in a direction of a Z-axis.

It may be understood that for ease of description, a sound outlet direction of the transducer 22 is defined as the direction of the Z-axis. A length direction of the first cantilever 233 is an X-axis. A Y-axis is perpendicular to the X-axis and the Z-axis. It may be understood that the coordinate system may alternatively be flexibly set based on a specific requirement. This is not specifically limited in this application.

In addition, the second piezoelectric driving mechanism 23b includes a second fixed base 232 and a second cantilever 234. A first end of the second cantilever 234 is fixedly connected to the second fixed base 232. A second end of the second cantilever 234 extends relative to the second fixed base 232. It may be understood that the first end of the second cantilever 234 is a fixed end relative to the second fixed base 232. The second end of the second cantilever 234 is a movable end relative to the second fixed base 232. For example, the second cantilever 234 also includes a piezoelectric sheet (not shown in the figure). When the piezoelectric sheet is energized, the piezoelectric sheet may be deformed, and the second end of the second cantilever 234 may reciprocally vibrate in the direction of the Z-axis.

In this implementation, in a same time period, a vibration direction of the first cantilever 233 is opposite to a vibration direction of the second cantilever 234. For example, a half period is used as an example for description. During (0, T/4), the first cantilever 233 vibrates in a positive direction of the Z-axis, and the second cantilever 234 vibrates in a negative direction of the Z-axis. During (T/4, T/2), the first cantilever 233 vibrates in the negative direction of the Z-axis, and the second cantilever 234 vibrates in the positive direction of the Z-axis. For example, when the second end of the first cantilever 233 moves in the positive direction of the Z-axis, the second end of the second cantilever 234 moves in the negative direction of the Z-axis, and the second end of the first cantilever 233 and the second end of the second cantilever 234 move in opposite directions.

As shown in FIG. 3, the base 21 is located between the first piezoelectric driving mechanism 23a and the second piezoelectric driving mechanism 23b. The second end (that is, the movable end) of the first cantilever 233 is connected to a first side 213 of the base 21. The second end (that is, the movable end) of the second cantilever 234 is connected to a second side 214 of the base 21. For example, both the second end (that is, the movable end) of the first cantilever 233 and the second end (that is, the movable end) of the second cantilever 234 may be connected to the second surface 212 of the base 21.

In an implementation, the base 21 and the driving apparatus 23 may alternatively form a modular assembly. Further, the base 21 and the driving apparatus 23 may form an integral structural member, that is, the base 21 is a part of the driving apparatus 23.

It may be understood that in the same time period, the vibration direction of the first cantilever 233 is opposite to the vibration direction of the second cantilever 234, and therefore a movement direction of the first side 213 of the base 21 is opposite to a movement direction of the second side 214 of the base 21. For example, a half period is used as an example for description. During (0, T/4), the first cantilever 233 drives the first side 213 of the base 21 to vibrate in the positive direction of the Z-axis, and the second cantilever 234 drives the second side 214 of the base 21 to vibrate in the negative direction of the Z-axis. During (T/4, T/2), the first cantilever 233 drives the first side 213 of the base 21 to vibrate in the negative direction of the Z-axis, and the second cantilever 234 drives the second side 214 of the base 21 to vibrate in the positive direction of the Z-axis. In this way, the base 21 can rotate relative to a rotating shaft G1 (schematically shown through a dashed line in FIG. 3). A connection position between the first cantilever 233 and the base 21 is a first position. A connection position between the second cantilever 234 and the base 21 is a second position. The rotating shaft G1 may be a virtual axis that passes through centers of the first position and the second position. For example, in the coordinate system in FIG. 3, the rotating shaft G1 may be a virtual axis that is parallel to the Y-axis and that may pass through a center of the base 21.

In an implementation, an angle at which the base 21 drives the transducer 22 to rotate is θ, and θ satisfies: −45°≤θ≤45°, that is, the base 21 may drive the transducer 22 to rotate within −45°≤θ≤45°. For example, 0 may be equal to −45°, −30°, −20°, −10°, 10°, 20°, 30°, or 45°. For example, with reference to FIG. 3, θ≤0° may be an angle at which the base 21 rotates counterclockwise on a plane X-Z when the first cantilever 233 drives the first side 213 of the base 21 to vibrate in the positive direction of the Z-axis, and the second cantilever 234 drives the second side 214 of the base 21 to vibrate in the negative direction of the Z-axis; θ>0° may be an angle at which the base 21 rotates clockwise on the plane X-Z when the first cantilever 233 drives the first side 213 of the base 21 to vibrate in the negative direction of the Z-axis, and the second cantilever 234 drives the second side 214 of the base 21 to vibrate in the positive direction of the Z-axis; and θ=0° may mean that the base 21 does not rotate relative to the plane X-Z when the first cantilever 233 does not drive the first side 213 of the base 21 to vibrate along the Z-axis, and the second cantilever 234 does not drive the second side 214 of the base 21 to vibrate along the Z-axis.

In an implementation, an angle at which the base 21 drives the transducer 22 to rotate is 0, and 0 satisfies: −30°≤θ≤30°, that is, the base 21 may drive the transducer 22 to rotate within −30°≤θ≤30°. For example, 0 may be equal to −30°, −20°, −10°, 10°, 20°, or 30°.

In an implementation, an angle at which the base 21 drives the transducer 22 to rotate is θ, and θ satisfies: −10°≤θ≤10°, that is, the base 21 may drive the transducer 22 to rotate within −10°≤θ≤10°. For example, θ may be equal to −10°, −5°, 5°, 8°, 10°, or the like. In another implementation, θ may satisfy another range.

In an implementation, the base 21 and the driving apparatus 23 may alternatively form a modular assembly. Further, the base 21 and the driving apparatus 23 may form an integral structural member, that is, the base 21 is a part of the driving apparatus 23.

As shown in FIG. 2 and FIG. 3, the control circuit 40 is electrically connected to the transducer 22 and the driving apparatus 23. The control circuit 40 is configured to generate a first control signal and a second control signal. It may be understood that the first control signal may include one or more signals, the second control signal may include one or more signals, and the first control signal and the second control signal are different signals.

In addition, the first control signal is coupled to the transducer 22, and the first control signal is used to drive the vibration member 222 of the transducer 22 to reciprocally vibrate, so that the transducer 22 generates the first sound wave. It may be understood that the coupling may be a direct electrical connection, or may be an indirect electrical connection. In some implementations, a frequency of the first control signal includes a first frequency f₁, and the first frequency f₁ is a single frequency or a wide band. For example, the first frequency f₁ is a single frequency, and the first frequency f₁ may be greater than or equal to 20 kHz. The vibration member 222 of the transducer 22 can reciprocally vibrate under driving of the first control signal, and a vibration frequency of the vibration member 222 may be greater than or equal to 20 kHz, that is, the vibration frequency of the vibration member 222 is an ultrasonic frequency. In this way, the first sound wave is an initial ultrasonic wave.

It may be understood that in a vibration process of the vibration member 222 of the transducer 22, the vibration member 222 of the transducer 22 may vibrate at different speeds or at a same speed at different moments or in different time periods.

In addition, the second control signal is coupled to the driving apparatus 23. The second control signal is used to control the driving apparatus 23, to drive the base 21 to drive the transducer 22 to perform periodic motion. In some implementations, a frequency of the second control signal includes a second frequency f₂, and the second frequency f₂ is a single frequency or a wide band. For example, the second frequency f₂ of the second control signal may be greater than or equal to 20 kHz. In this case, the driving apparatus 23 can drive the base 21 to drive the transducer 22 to perform periodic motion, and a frequency of periodic motion between the base 21 and the transducer 22 may be greater than or equal to 20 KHz.

It may be understood that the periodic motion includes reciprocating rotation, continuous rotation, and reciprocating translation. In a process in which the base 21 drives the transducer 22 to perform periodic motion, speeds at which the base 21 drives the transducer 22 to move may be different or may be the same at different moments or in different time periods.

Driving apparatuses of different structures may correspond to different periodic motion. For example, the driving apparatus 23 shown in FIG. 3 is used as an example for description. For example, the second control signal is configured to control the movable end of the first cantilever 233 and the movable end of the second cantilever 234 to perform reciprocating vibration. The movable end of the first cantilever 233 and the movable end of the second cantilever 234 drive the base 21 to drive the transducer 22 to perform reciprocating rotation. In this way, the driving apparatus 23 shown in FIG. 3 may implement periodic motion of reciprocating rotation for the base 21. That the driving apparatus 23 is configured to implement periodic motion of continuous rotation and reciprocating motion for the base 21 is described in detail below with reference to related accompanying drawings. Details are not described herein again.

It may be understood that in this implementation, the transducer 22 emits the first sound wave at the first frequency of f₁ to the outside while performing periodic motion at the second frequency of f₂. In this case, the first sound wave can be modulated in the space to form the second sound wave. The second sound wave may include an audible sound. A frequency of the audible sound may be less than a frequency of the first sound wave. In some implementations, the transducer 22 emits an ultrasonic wave (at a frequency greater than or equal to 20 kHz) to the outside while performing periodic motion at a frequency greater than or equal to 20 kHz. In this case, because the ultrasonic wave has specific directivity, main lobe energy of the ultrasonic wave moves synchronously in a moving process, so that a sound wave amplitude at least one position in the space changes. In this way, the ultrasonic wave can be modulated in the space to form the second sound wave. The second sound wave may include an audible sound.

With reference to the foregoing accompanying drawings, the following describes in detail a principle of generating an audible sound by the sound generation apparatus 100.

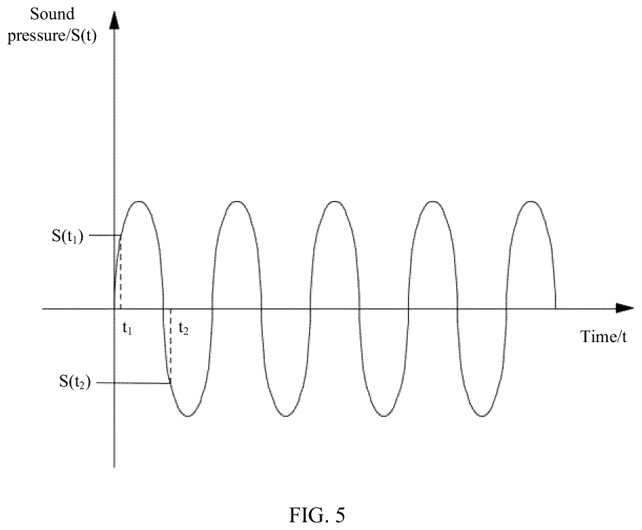

FIG. 5 is a diagram of a sound wave emitted by the transducer 22 shown in FIG. 4 in an implementation.

It is assumed that the frequency of the first control signal includes the first frequency f₁, and the first frequency f₁ is a single frequency or a wide band. For example, the first control signal V′ includes a term (1):

$${V}_{1} sin ( 2 π {f}_{1} t ) \qquad ( 1 )$$

Herein, V₁ is a constant.

As shown in FIG. 5, the transducer 22 emits the first sound wave under the driving of the first control signal. In this case, the first sound wave s(t) in the space includes a term (2):

$${S}_{0} sin ( 2 π {f}_{1} t ) \qquad ( 2 )$$

Herein, S₀ is a constant. It may be learned from the term (2) that the vibration frequency of the vibration member 222 of the transducer 22 includes the first frequency f₁, and the first frequency f₁ is a single frequency or a wide band.

It may be learned from FIG. 5 that in the expression of the first sound wave, each moment t corresponds to one sound pressure value s(t), and each sound pressure value s(t) is related to an amplitude S₀. For example, when t=t₁, s(t) includes S₀ sin (2πf₁t₁), that is, a moment t₁ corresponds to a sound pressure value s(t₁), and is related to the amplitude S₀. For another example, when t=t₂, s(t) includes S₀ sin (2πf₁t₂), that is, a moment t₂ corresponds to a sound pressure value s(t₂), and is related to the amplitude S₀.

In addition, it is assumed that the frequency of the second control signal includes the second frequency f₂, and the second frequency f₂ is a single frequency or a wide band. For example, the second control signal V″ includes a term (3):

$${V}_{2} sin ( 2 π {f}_{2} t ) \qquad ( 3 )$$

Herein, V₂ is a constant.

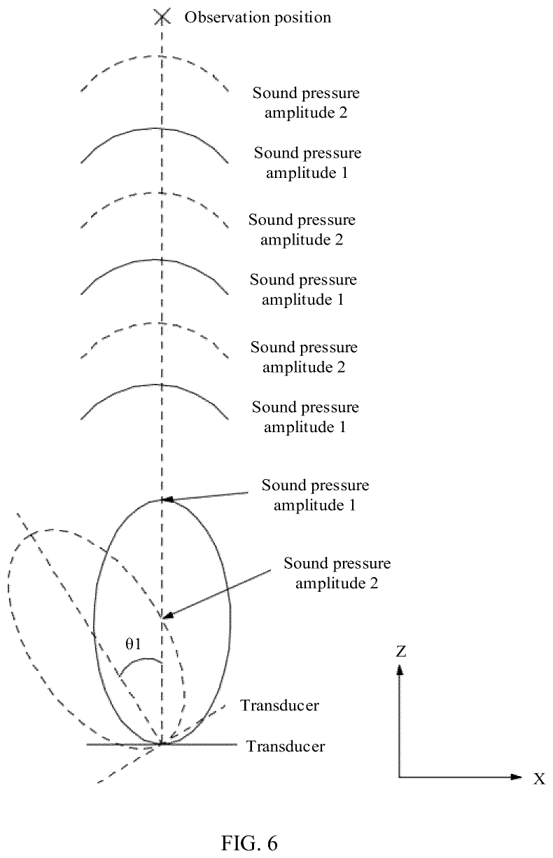

FIG. 6 is a first diagram of a sound generation principle of the sound generation apparatus 100 shown in FIG. 3. As shown in FIG. 6, when the driving apparatus 23 drives, under control of the second control signal at the second frequency of f₂, the base 21 to drive the transducer 22 to perform periodic motion, the base 21 drives the transducer 22 to perform periodic motion. The following uses an example in which the base 21 drives the transducer 22 to perform a periodic motion of reciprocating rotation for description.

In this way, under control of the second frequency f₂ of the second control signal, the angle θ at which the base 21 drives the transducer 22 to rotate includes a term (4):

$${k}_{1} {V}_{2} sin ( 2 π {f}_{2} t ) \qquad ( 4 )$$

Herein, k₁ is a constant.

In addition, it may be learned from the term (4) that a motion frequency of the transducer 22 includes the second frequency f₂, and the second frequency f₂ is a single frequency or a wide band.

For example, in a process in which the base 21 drives the transducer 22 to perform reciprocating rotation, the angle at which the base 21 drives the transducer 22 to rotate is θ. When θ=0°, the vibration member 222 of the transducer 22 may be parallel to a plane XY. When θ=θ1 (θ1 >0 or θ1≤0), the vibration member 222 of the transducer 22 may intersect with or not be parallel to the plane XY. FIG. 6 shows energy distribution of a main lobe of the first sound wave when θ=0° through a solid line similar to a water drop shape. FIG. 6 shows energy distribution of a main lobe of the first sound wave when θ=01 through a dashed line similar to a water drop shape.

It may be understood that it is assumed that the first sound wave is observed at an observation position (the position is shown by using a cross in FIG. 6). When θ=0°, the observation position is located directly in front of a sound output surface of the transducer 22, and directly faces a position of a sound pressure amplitude 1 of the first sound wave (that is, a position of a maximum value of a sound pressure amplitude), that is, the sound pressure amplitude 1. When θ=θ1 (θ1 >0 or θ1≤0), the sound pressure amplitude changes from the sound pressure amplitude 1 to a sound pressure amplitude 2, and the sound pressure amplitude 2 is less than the sound pressure amplitude 1. When the base 21 drives the transducer 22 to perform reciprocating rotation, the sound pressure amplitude reciprocally changes.

It may be understood that in this implementation, the observation position directly faces the position of the maximum value of the sound pressure amplitude when θ=0°. In another implementation, the observation position may be flexibly set. For example, the observation position may alternatively directly face any position on an edge of energy of the main lobe of the first sound wave when θ=0°, that is, any position on an edge of the water drop shape in FIG. 6. Certainly, in another implementation, the observation position may alternatively directly face any position on the edge of the energy of the main lobe of the first sound wave when θ=01.

The transducer 22 is driven by the base 21 to form reciprocating rotation at a frequency of f₂, and a sound pressure amplitude at least one position in the space changes accordingly. It may be obtained that a sound field s′ (t) in the space includes a term (5):

$${S}_{1} sin ( 2 π {f}_{1} t ) sin ( 2 π {f}_{2} t ) \qquad ( 5 )$$

Herein, S₁ is a constant.

The term (5) may be converted as follows by using mathematical product-to-sum formulas:

$$A cos [ 2 π ( {f}_{1} + {f}_{2} ) t ] + B cos [ 2 π ( {f}_{1} - {f}_{2} ) t ] \qquad ( 6 )$$

Herein, A and B are constants.

In addition, based on the term (6), it may be found that the first sound wave emitted by the transducer 22 is modulated to form the second sound wave. The second sound wave may include at least sound waves at two frequencies, and the frequencies of the sound waves are respectively |f₁+f₂| and |f₁−f₂|.

In some specific embodiments, the transducer 22 is disposed to emit the first sound wave at the first frequency of f₁ to the outside while performing reciprocating rotation at the second frequency of f₂. In this case, in a process of reciprocating rotation of the transducer 22, a sound pressure amplitude received at least one position in the space changes, and in this case, the first sound wave is modulated to form the second sound wave. The second sound wave may include sound waves at two frequencies. It may be understood that this modulation manner may also be referred to as sound pressure amplitude modulation.

It may be understood that in the term (5), a value of S₁ is related to a rotation angle of the base 21. A larger rotation angle of the base 21 indicates higher energy of the audible sound. A smaller rotation angle of the base 21 indicates better linearity of the audible sound. In an implementation, when the base 21 drives the transducer 22 to rotate within −45°≤θ≤45°, it can be ensured that the audible sound has good linearity and very high energy. In an implementation, when the base 21 drives the transducer 22 to rotate within −30°≤θ≤30°, the audible sound has good linearity and high energy. In an implementation, when the base 21 drives the transducer 22 to rotate within −10°≤≤10°, it can be ensured that the audible sound has high energy and very good linearity.

It may be understood that it may be learned from the foregoing that the first sound wave emitted by the transducer 22 is modulated to form the second sound wave. The second sound wave may include at least sound waves at two frequencies, and the frequencies of the sound waves are respectively |f₁+f₂| and |f₁−f₂|. Therefore, a sound wave at the frequency of |f₁+f₂| may be filtered out by using a sound wave filtering technology, to retain a sound wave at |f₁−f₂|. Alternatively, a sound wave at the frequency of |f₁−f₂| is filtered out, to retain a sound wave at |f₁+f₂|.

In some implementations, values of the first frequency f₁ and the second frequency f₂ may be set, so that a frequency of one sound wave in the second sound wave falls within a range of an ultrasonic wave, and a frequency of the other sound wave falls within a frequency range of an audible sound. In this way, because the ultrasonic wave may be automatically filtered out by a human ear, the user may hear one sound wave in the space, and the sound wave is an audible sound.

It may be understood that to more concisely determine a relationship between the frequencies of |f₁−f₂| and |f₁+f₂|, the expressions of the two frequencies are further simplified. Further, f₁=f₀ Hz and f₂=(f₀−Δ) Hz are defined. In this way, |f₁+f₂|=(2f₀−Δ) Hz and |f₁−f₂|=Δ Hz.

In an implementation, Δ is set to be in a range of 20 to 48000, that is, 20≤Δ≤48000. For example, Δ may be 20, 200, 2000, 24000, 48000, or the like. In this way, in this case, the frequency of |f₁−f₂| falls within a range of 20 Hz to 48 KHz.

In an implementation, Δ is set to be in a range of 20 to 24000, that is, 20≤Δ≤24000. For example, Δ may be 20, 200, 2000, 24000, or the like. In this way, in this case, the frequency of |f₁−f₂| falls within a range of 20 Hz to 24 kHz.

In an implementation, Δ is set to be in a range of 20 to 20000, that is, 20≤Δ≤20000. For example, Δ may be 20, 200, 2000, 20000, or the like. In this way, the frequency of |f₁−f₂| falls within a range of 20 Hz to 20 kHz, that is, a sound wave at the frequency of |f₁−f₂| may fall within a frequency range of an audible sound. In this case, at least a part of the second sound wave includes an audible sound. In another implementation, A may alternatively be another value.

In an implementation, (2f₀−Δ) is set to be greater than 20000, that is, (2f₀−Δ)≥20 KHz. For example, (2f₀−Δ) may be 40 kHz, 50 kHz, 80 kHz, or the like. In this way, in this case, the frequency |f₁+f₂| is greater than 20 kHz, that is, a sound wave at the frequency of |f₁+f₂| can fall within a frequency range of an ultrasonic wave, and the sound wave at the frequency of |f₁+f₂| in the space cannot be heard by a human. In another implementation, (2f₀-Δ) may alternatively be another value.

In an implementation, both f₁ and f₂ are ultrasonic frequencies, that is, the first frequency f₁ is greater than 20 kHz, and the second frequency f₂ is greater than 20 kHz. For example, f₁=40 kHz and f₂=30 kHz. It may be understood that both f₁ and f₂ are set to ultrasonic wave frequencies, to ensure that |f₁+f₂| can definitely fall within an ultrasonic wave range, and ensure that a sound wave at the frequency of |f₁+f₂| in the space cannot be heard by a human.

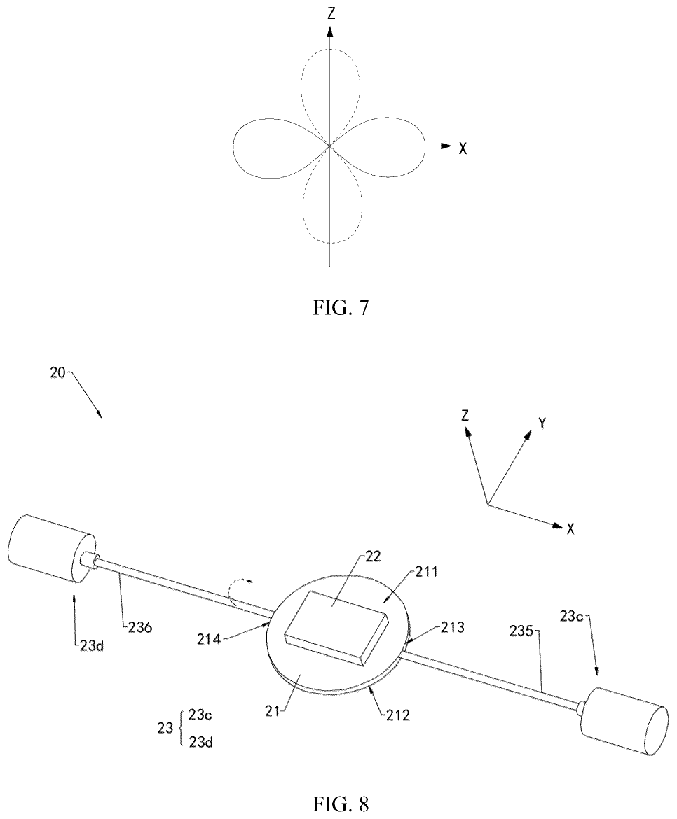

FIG. 7 is a diagram of energy distribution of a sound wave emitted by the sound generation apparatus 100 shown in FIG. 3 and energy distribution of a main lobe of the first sound wave emitted by the transducer 22.

FIG. 7 shows the energy distribution of the main lobe of the first sound wave through a dashed line in a shape of “8”. FIG. 7 shows energy distribution of the audible sound through a solid line in a shape of “8”. It may be understood that the first sound wave has directivity. The first sound wave has greater energy distribution in the direction of the Z-axis, that is, the first sound wave has a higher sound pressure level in the direction of the Z-axis. However, the audible sound formed by modulating the first sound wave has greater energy distribution in a direction of the X-axis, that is, the audible sound has a higher sound pressure level in the direction of the X-axis. Therefore, the audible sound formed by modulating the first sound wave also has sound wave directivity. Therefore, the sound generation apparatus in this implementation may be suitable for some private scenarios. The sound generation apparatus 100 may play a sound in a specific direction or toward a specific user. For example, in a private call scenario, when a user makes a call and does not want another person to hear a downlink sound of the call, the sound has directivity, so that the sound is emitted only toward the user and cannot be heard by a surrounding person. For another example, in a music exclusive scenario, when another person rests around and a user wants to enjoy audio and video entertainment, the sound has directivity, so that the sound is emitted only toward the user and cannot be heard by a surrounding person, so as not to disturb the surrounding person.

It may be understood that it may be learned from the derivation process of the formula (1) to the formula (6) that the transducer 22 emits the first sound wave at the first frequency of f₁ under the driving of the first control signal. For an audio signal that can generate music, the audio signal is a wideband signal. In this case, the first sound wave s(t) includes a term (7):

$${S}_{0} a ( t ) sin ( 2 π {f}_{0} t ) \qquad ( 7 )$$

Herein, a(t) is music information, S₀ is a sound wave amplitude, and f₀ is a working frequency.

In addition, because the base 21 rotates at the working frequency of f₀ to modulate the sound wave, the second sound wave s′^{(t)} includes a term (8):

$${S}_{1} a ( t ) sin ( 2 π {f}_{0} t ) sin ( 2 π {f}_{0} t ) \qquad ( 8 )$$

Herein, S₁ is a constant.

It may be understood that for generation of the formula (8), refer to the derivation process of the formula (1) to the formula (6). Details are not described herein again.

The structure and the sound generation principle of the sound generation apparatus 100 are described in detail above with reference to the related accompanying drawings. It may be understood that in this implementation, the sound generation apparatus 100 no longer uses another speaker structure, but instead the transducer 22 is disposed to emit the first sound wave at the first frequency of f₁ to the outside while performing periodic motion at the second frequency of f₂. In this case, the first sound wave can be modulated in the space to form the second sound wave. The second sound wave may include an audible sound. In some implementations, the transducer 22 emits an ultrasonic wave (at a frequency greater than or equal to 20 kHz) to the outside while performing periodic motion at a frequency greater than or equal to 20 kHz. In this case, because the ultrasonic wave has specific directivity, main lobe energy of the ultrasonic wave moves synchronously in a moving process, so that a sound wave amplitude at least one position in the space changes. In this way, the ultrasonic wave can be modulated in the space to form the second sound wave. The second sound wave may include an audible sound.

In some implementations, the first sound wave is an ultrasonic wave, that is, the transducer 22 is an ultrasonic transducer. This is implemented by a vibration action of the vibration member 222 of the transducer 22. The frequency of the audible sound is less than the frequency of the first sound wave. Therefore, the frequency of the audible sound is less than the vibration frequency of the vibration member 222. Compared with another speaker that generates a sound at a same sound pressure level, vibration displacement of the vibration member 222 of the transducer 22 in this implementation is less than vibration displacement of a diaphragm of the other speaker.

It may be understood that the sound generation apparatus 100 may obtain an audible sound at a high sound pressure level through small displacement vibration of the vibration member 222 of the ultrasonic transducer 22. A low-frequency response of the sound generation apparatus 100 has no or basically has no roll-off characteristic, a low-frequency roll-off of the sound generation apparatus 100 is significantly less than 12 dB, and the sound generation apparatus 100 can have a high low-frequency sound pressure level in a case of a small volume. The sound generation apparatus 100 with a small volume has wider applicability in scenarios with space requirements.

It may be understood that the sound generation apparatus 100 in this implementation may be used in a back cavity with a limited volume, and may still achieve strong low-frequency performance.

In an implementation, Fourier transform is applied to the formula (7), to obtain a frequency domain that includes a term A(f−f₀)+A(f+f₀). Herein, A(f) is a spectrum of the music. In addition, there are sound waves on a lower sideband (f−f₀) and an upper sideband (f+f₀) near the working frequency f₀. In this implementation, when the first control signal is provided to the transducer 22, the first control signal may be filtered, so that the first control signal includes only the upper sideband or the lower sideband, and a sound wave on the corresponding sideband participates in modulation. In this case, the frequency domain of the first control signal may include a term A(f−f₀) or a term A(f+f₀).

In addition, Fourier transform is applied to the term (8), to obtain a frequency domain that includes a term A(f)+A(f−2f₀)+A(f+2f %). It may be learned from this term that the term (8) has a spectrum A(f) of the music.

A sound generation principle of the transducer 22 is described above with reference to the related accompanying drawings. With reference to related accompanying drawings, the following describes in detail several structures of the driving apparatus 23 for driving the base 21 to perform periodic motion.

FIG. 8 is a diagram of a structure of the sound generation component 20 of the sound generation apparatus 100 shown in FIG. 2 in another implementation.

In an implementation, the driving apparatus 23 may be a driving apparatus 23 with an electromagnetic driving force. For example, the driving apparatus 23 is a motor, which is also referred to as a motor. In another implementation, the driving apparatus 23 may alternatively be a motor with a piezoelectric driving force. The motor is not specifically limited in this application.

The driving apparatus 23 includes a first motor 23c and a second motor 23d. The first motor 23c has a first output shaft 235. When the first motor 23c is energized, the first output shaft 235 may rotate. The second motor 23d has a second output shaft 236. When the second motor 23d is energized, the second output shaft 236 may rotate.

In this implementation, the base 21 is located between the first motor 23c and the second motor 23d. The first output shaft 235 of the first motor 23c is connected to the first side 213 of the base 21. The second output shaft 236 of the second motor 23d is connected to the second side 214 of the base 21. For example, the first output shaft 235 of the first motor 23c may be transmitted or linked to the first side 213 of the base 21 through a transmission mechanism such as a gear or a linkage mechanism. The second output shaft 236 of the second motor 23d may also be transmitted or linked to the second side 214 of the base 21 through a structure such as a gear.

For example, in a same time period, a rotation direction of the first output shaft 235 of the first motor 23c is the same as a rotation direction of the second output shaft 236 of the second motor 23d. In this case, in the same time period, a rotation direction of the first side 213 of the base 21 is the same as a rotation direction of the second side 214 of the base 21. For example, a half period is used as an example for description. During (0, T/4), the first output shaft 235 of the first motor 23c drives the first side 213 of the base 21 to rotate in a clockwise direction of an X-axis, and the second output shaft 236 of the second motor 23d drives the second side 214 of the base 21 to rotate in the clockwise direction of the X-axis. During (T/4, T/2), the first output shaft 235 of the first motor 23c drives the first side 213 of the base 21 to rotate in a counterclockwise direction of the X-axis, and the second output shaft 236 of the second motor 23d drives the second side 214 of the base 21 to rotate in the counterclockwise direction of the X-axis. In this way, the base 21 can rotate relative to a virtual rotating shaft. The virtual rotating shaft may be an extension line of the first output shaft 235, an extension line of the second output shaft 236, or a connection line between the first output shaft 235 and the second output shaft 236.

It may be understood that for ease of description, a sound outlet direction of the transducer 22 is defined as a direction of a Z-axis. A length direction of the first output shaft 235 is the X-axis. A Y-axis is perpendicular to the X-axis and the Z-axis. It may be understood that the coordinate system in this implementation may alternatively be flexibly set based on a specific requirement.

For example, the first output shaft 235 of the first motor 23c and the second output shaft 236 of the second motor 23d are disposed in parallel. In this way, the first motor 23c and the second motor 23d may synchronously drive the base 21 to perform reciprocating rotation or continuous rotation.

In an implementation, the first output shaft 235 of the first motor 23c and the second output shaft 236 of the second motor 23d may be configured to drive the base 21 to perform reciprocating rotation.

In an implementation, an angle at which the base 21 drives the transducer 22 to rotate is θ, and θ satisfies: −45°≤θ≤45°. For example, 0 may be equal to −45°, −20°, −10°, 10°, 20°, or 45°. In this way, the base 21 may rotate in a range of −45° to 45°.

In an implementation, an angle at which the base 21 drives the transducer 22 to rotate is 0, and 0 satisfies: −30°≤θ≤30°. For example, 0 may be equal to −30°, −20°, −10°, 10°, 20°, or 30°. In this way, the base 21 may rotate in a range of−30° to 30°.

In an implementation, an angle at which the base 21 drives the transducer 22 to rotate is θ, and θ may alternatively satisfy: −10°≤θ≤10°. For example, θ may be equal to −10°, −5°, 5°, 8°, 10°, or the like. In this way, the base 21 may rotate in a range of−10° to 10°.

In another implementation, θ may alternatively fall within another range, for example, in a range of 0° to 120°, a range of 0° to 150°, a range of 0° to 200°, a range of 0° to 240°, a range of 0° to 300°, or a range of 0° to 330°. This is not specifically limited in this application.

It may be understood that the first motor 23c and the second motor 23d can perform reciprocating rotation under the second control signal. In this case, the first motor 23c and the second motor 23d can drive the base 21 to drive the transducer 22 to perform reciprocating rotation. In an implementation, a frequency of reciprocating motion between the base 21 and the transducer 22 may be greater than or equal to 20 kHz. In addition, the vibration member 222 of the transducer 22 can vibrate under driving of the first control signal. In an implementation, a vibration frequency of the vibration member 222 is greater than or equal to 20 kHz, that is, the vibration frequency of the vibration member 222 is an ultrasonic frequency, and the first sound wave is an initial ultrasonic wave. In this way, the transducer 22 emits the first sound wave to the outside while performing reciprocal rotation at a specific frequency. The first sound wave can be modulated in the space to form the second sound wave. The second sound wave may include an audible sound.

In an implementation, both an extension direction of the first output shaft 235 of the first motor 23c and an extension direction of the second output shaft 236 of the second motor 23d may pass through a central position of the base 21. In this way, the base 21 has good stability in a rotation process. In another implementation, both a connection position between the first output shaft 235 of the first motor 23c and the base 21 and a connection position between the second output shaft 236 of the second motor 23d and the base 21 are not specifically limited.

In this implementation, the first motor 23c, the second motor 23d, and the base 21 are arranged in a direction of the X-axis. In another implementation, the first motor 23c, the second motor 23d, and the base 21 may alternatively be arranged in a direction of the Z-axis. In this case, the first output shaft 235 of the first motor 23c may be connected to the first surface 211 of the base 21, and the second output shaft 236 of the second motor 23d may be connected to the second surface 212 of the base 21. It may be understood that the first output shaft 235 of the first motor 23c may be perpendicular to the first surface 211 of the base 21, or may be disposed at an acute angle with the first surface 211 of the base 21. The second output shaft 236 of the second motor 23d may be perpendicular to the second surface 212 of the base 21, or may be disposed at an acute angle with the second surface 212 of the base 21.

In an implementation, the first output shaft 235 of the first motor 23c and the second output shaft 236 of the second motor 23d may be configured to drive the base 21 to perform continuous rotation. In this case, an angle θ at which the base 21 drives the transducer 22 to rotate falls within a range of 0° to 360°. In this case, the base 21 drives the transducer 22 to perform continuous rotation within 360°.

It may be understood that the first motor 23c and the second motor 23d can perform continuous rotation under the second control signal. In this case, the first motor 23c and the second motor 23d can drive the base 21 to drive the transducer 22 to perform continuous rotation. In an implementation, a frequency of continuous motion between the base 21 and the transducer 22 may be greater than or equal to 20 kHz. In addition, the vibration member 222 of the transducer 22 can vibrate under driving of the first control signal. A vibration frequency of the vibration member 222 is greater than or equal to 20 kHz, that is, the vibration frequency of the vibration member 222 is an ultrasonic frequency, and the first sound wave is an initial ultrasonic wave. In this way, the transducer 22 emits the first sound wave to the outside while performing continuous rotation at a specific frequency. The first sound wave can be modulated in air to form the second sound wave. The second sound wave may include an audible sound.

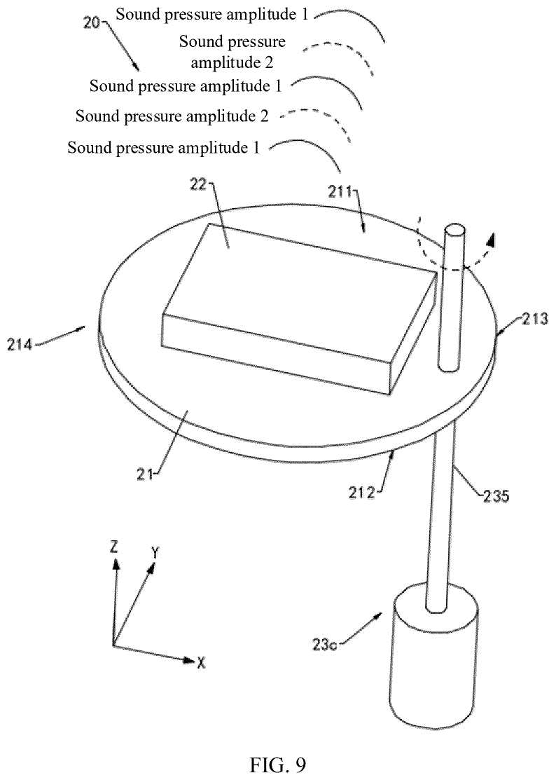

FIG. 9 is a diagram of a structure of the sound generation component 20 of the sound generation apparatus 100 shown in FIG. 2 in still another implementation.

As shown in FIG. 9, in an implementation, the first output shaft 235 of the first motor 23c is connected to the base 21. The first output shaft 235 of the first motor 23c may run through the first surface 211 of the base 21 to the second surface 212. In this way, when the first motor 23c is energized, the first output shaft 235 of the first motor 23c may drive the base 21 to rotate. A rotating shaft of the base 21 may be the first output shaft 235. It may be understood that for an angle range in which the first motor 23c drives the base 21 to rotate, refer to the foregoing setting of the angle θ at which the first motor 23c and the second motor 23d drive the base 21 to drive the transducer 22 to rotate. This is not specifically limited in this application.

It may be understood that the first output shaft 235 of the first motor 23c runs through the first surface 211 of the base 21 to the second surface 212, so that the base 21 can be more stable in a rotation process. In another implementation, the first output shaft 235 may not need to run to the second surface 212. In another implementation, the first output shaft 235 may run through the second surface 212 of the base 21 to the first surface 211.

It may be understood that FIG. 3 and FIG. 8 show that the rotating shaft (for example, the first output shaft 235 of the first motor 23c) of the base 21 may be located on a plane on which the base 21 is located (for example, the rotating shaft of the base 21 is parallel to the plane on which the base 21 is located). However, in this implementation, the rotating shaft (for example, the first output shaft 235 of the first motor 23c) of the base 21 may be perpendicular to or intersect with the plane on which the base 21 is located.

It may be understood that to change a sound wave amplitude at least one position in the space and implement that the first sound wave can be modulated in the space to form the second sound wave, where the second sound wave may include an audible sound, a position of a rotating shaft of the transducer 22 is set in a specific manner. The following analyzes in detail the three driving apparatuses 23 shown in FIG. 3, FIG. 8, and FIG. 9.

It may be understood that in the three implementations shown in FIG. 3, FIG. 8, and FIG. 9, the driving apparatus 23 drives, through the base 21, the transducer 22 to perform continuous rotation or reciprocating rotation. In this way, the rotating shaft of the base 21 and the rotating shaft of the transducer 22 are the same. Therefore, a setting of the rotating shaft of the transducer 22 is the same as a setting of the rotating shaft of the base 21. The following uses the rotating shaft of the base 21 as an example for description.

When the transducer 22 is disposed at the center of the base 21, and the rotating shaft of the base 21 uses the manner (that is, the rotating shaft of the base 21 is located on the plane on which the base 21 is located) shown in FIG. 3 and FIG. 8, a position of the rotating shaft of the base 21 is not specifically limited.

When the transducer 22 is disposed at the center of the base 21, and the rotating shaft of the base 21 uses the manner (the rotating shaft of the base 21 is perpendicular to or intersects with the plane on which the base 21 is located) shown in FIG. 9, a specific position of the rotating shaft of the base 21 is related to perpendicular and intersecting solutions.

For example, when the rotating shaft of the base 21 is perpendicular to the plane on which the base 21 is located, the position of the rotating shaft of the base 21 may be set based on an energy shape of the main lobe of the first sound wave. When the energy shape of the main lobe of the first sound wave is a symmetric structure, the position of the rotating shaft of the base 21 may be set to be eccentric (that is, the position of the rotating shaft deviates from the center of the base 21). When the energy shape of the main lobe of the first sound wave is an asymmetric structure, the position of the rotating shaft of the base 21 may be any position. It may be understood that FIG. 9 shows that the rotating shaft of the base 21 is perpendicular to the plane on which the base 21 is located. Therefore, considering that the energy shape of the main lobe of the first sound wave is a symmetric structure, FIG. 9 shows that the first output shaft 235 of the first motor 23c is connected to the first side 213 of the base 21 to set the position of the rotating shaft of the base 21 to be eccentric. Certainly, in another implementation, the first output shaft 235 of the first motor 23c is connected to the second side 214 of the base 21 to set the position of the rotating shaft of the base 21 to be eccentric.

For another example, when the rotating shaft of the base 21 intersects with the plane on which the base 21 is located, the position of the rotating shaft of the base 21 may be any position.

When the transducer 22 is not disposed at the center of the base 21, regardless of whether the rotating shaft of the base 21 uses the manner shown in FIG. 3 and FIG. 8 or the manner shown in FIG. 9, a position of the rotating shaft of the base 21 is not specifically limited.

In another implementation, when the sound generation apparatus 100 does not include the base 21, the driving apparatus 23 may directly drive the transducer 22 to perform continuous rotation or reciprocating rotation. In this case, to change a sound wave amplitude at least one position in the space and implement that the first sound wave can be modulated in the space to form the second sound wave, where the second sound wave may include an audible sound, a position of a rotating shaft of the transducer 22 is set in a specific manner. The following analyzes in detail the three driving apparatuses 23 shown in FIG. 3, FIG. 8, and FIG. 9.

When the rotating shaft of the transducer 22 uses the manner shown in FIG. 3 and FIG. 8, that is, the rotating shaft of the transducer 22 is located on a plane on which the transducer 22 is located (for example, the rotating shaft of the transducer 22 is parallel to the plane on which the transducer 22 is located), the position of the rotating shaft of the transducer 22 is not specifically limited.

When the rotating shaft of the transducer 22 uses the manner shown in FIG. 9 (the rotating shaft of the transducer 22 is perpendicular to or intersects with a plane on which the transducer 22 is located), a specific position of the rotating shaft of the transducer 22 is related to perpendicular and intersecting solutions.

For example, when the rotating shaft of the transducer 22 is perpendicular to the plane on which the transducer 22 is located, the position of the rotating shaft of the transducer 22 may be set based on an energy shape of the main lobe of the first sound wave. When the energy shape of the main lobe of the first sound wave is a symmetric structure, the position of the rotating shaft of the transducer 22 may be set to be eccentric (that is, the position of the rotating shaft of the transducer 22 deviates from a center of the transducer 22). When the energy shape of the main lobe of the first sound wave is an asymmetric structure, the position of the rotating shaft of the transducer 22 may be any position.

For another example, when the rotating shaft of the transducer 22 intersects with the plane on which the transducer 22 is located, the position of the rotating shaft of the transducer 22 may be any position.

The driving apparatus 23 described above is described by using an example in which the base 21 is driven to rotate. The following further describes a driving apparatus 23 in detail with reference to related accompanying drawings. The driving apparatus 23 may be configured to drive the base 21 to drive the transducer 22 to perform translational motion within a specific displacement range.

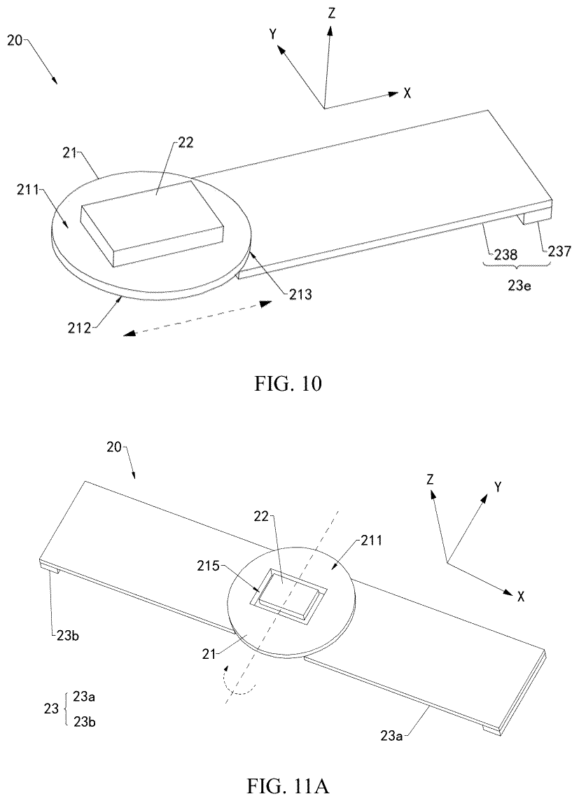

FIG. 10 is a diagram of a structure of the sound generation component 20 of the sound generation apparatus 100 shown in FIG. 2 in still another implementation.

As shown in FIG. 10, in an implementation, the driving apparatus 23 includes a telescopic mechanism 23e. The telescopic mechanism 23e may be a magnetostrictively driven mechanism, or may be an electromagnetically driven mechanism, a piezoelectrically driven mechanism, an electrostatically driven mechanism, or a mechanism driven in another manner.

Further, the telescopic mechanism 23e includes a fixed base 237 and a telescopic arm 238. A first end of the telescopic arm 238 is fixedly connected to the fixed base 237. A second end of the telescopic arm 238 extends relative to the fixed base 237. It may be understood that the first end of the telescopic arm 238 is a fixed end relative to the fixed base 237. The second end of the telescopic arm 238 is a movable end relative to the fixed base 237. For example, the telescopic arm 238 may include a piezoelectric sheet (not shown in the figure). When the piezoelectric sheet is energized, the piezoelectric sheet may be deformed (for example, warped, bent, or arched). In this case, the telescopic arm 238 may perform reciprocating extension and retraction motion in a direction of an X-axis. For example, the telescopic arm 238 may perform extension motion in a positive direction of the X-axis. The telescopic arm 238 may further perform retraction motion in a negative direction of the X-axis. In another implementation, a direction in which the telescopic arm 238 extends and retracts may be any direction on a plane X-Y, or may be a direction of a Z-axis. This is not specifically limited in this application.

As shown in FIG. 10, the second end (that is, the movable end) of the telescopic arm 238 is connected to the first side 213 of the base 21. In this way, when the telescopic arm 238 performs reciprocating translational motion in the direction of the X-axis, the telescopic arm 238 may drive the base 21 to drive the transducer 22 to perform reciprocating translational motion in the direction of the X-axis. For example, one period is used as an example for description. During (0, T/4), the telescopic arm 238 may drive the base 21 to drive the transducer 22 to perform translational motion from an initial position to a first position in the positive direction of the X-axis. During (T/4, T/2), the telescopic arm 238 may drive the base 21 to drive the transducer 22 to perform translational motion from the first position to the initial position in the negative direction of the X-axis. During (T/2, 3T/4), the telescopic arm 238 may drive the base 21 to drive the transducer 22 to perform translational motion from the initial position to a second position in the negative direction of the X-axis. During (3T/4, T), the telescopic arm 238 may drive the base 21 to drive the transducer 22 to perform translational motion from the second position to the initial position in the positive direction of the X-axis.

It may be understood that the telescopic mechanism 23e can perform reciprocating extension and retraction motion under the second control signal. In this case, the telescopic mechanism 23e can drive the base 21 to drive the transducer 22 to perform reciprocating translational motion. In an implementation, a frequency of reciprocating motion between the base 21 and the transducer 22 may be greater than or equal to 20 kHz. In addition, the vibration member 222 of the transducer 22 can reciprocally vibrate under driving of the first control signal, and a vibration frequency of the vibration member 222 is greater than or equal to 20 kHz, that is, the vibration frequency of the vibration member 222 is an ultrasonic frequency, and the first sound wave is an initial ultrasonic wave. In this way, the transducer 22 emits an ultrasonic wave to the outside while performing reciprocating translational motion at a specific frequency. In this case, the ultrasonic wave can be modulated in the space to form the second sound wave. The second sound wave may include an audible sound.

The structure of the driving apparatus 23 is not limited to the several structures described above. It may be understood that all driving apparatuses 23 that can implement reciprocating motion under the second control signal may be used as the driving apparatus 23 in this application. This is not specifically limited in this application. The following further describes several structures of the sound generation apparatus in detail with reference to related accompanying drawings.

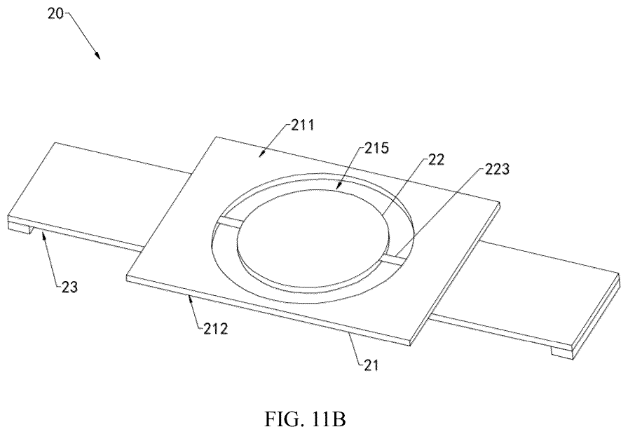

FIG. 11A is a diagram of a structure of the sound generation component 20 of the sound generation apparatus 100 shown in FIG. 2 in still another implementation.

As shown in FIG. 11A, in an implementation, the base 21 is provided with accommodation space 215. The accommodation space 215 may be of a groove structure or a through-hole structure. An example in which the accommodation space 215 is of a groove structure is used for description. The accommodation space 215 forms an opening on the first surface 211 of the base 21. At least a part of the transducer 22 is located in the accommodation space 215. In this way, there is an overlapping region between the transducer 22 and the base 21 in a thickness direction, to facilitate thinning of the sound generation apparatus 100 in the thickness direction.

In an implementation, a top surface of the transducer 22 may be flush with the first surface 211 of the base 21, or a top surface of the transducer 22 is lower than the first surface 211 of the base 21. In this way, a dimension of the sound generation apparatus 100 in the thickness direction may be greatly reduced.

It may be understood that the structural feature in this implementation may be combined with the sound generation apparatus 100 in the foregoing implementations. Details are not described herein again.

FIG. 11B is a diagram of a structure of the sound generation component 20 of the sound generation apparatus 100 shown in FIG. 2 in still another implementation.

As shown in FIG. 11B, in an implementation, the base 21 is provided with accommodation space 215. The accommodation space 215 may be of a groove structure or a through-hole structure. An example in which the accommodation space 215 is of a through-hole structure is used for description. The accommodation space 215 forms openings on the first surface 211 and the second surface 212 of the base 21.

In this implementation, the vibration member 222 is connected to a wall surface of the accommodation space 215 through a connecting piece 223. The connecting piece 223 may be of a rod structure, or may be of a cantilever structure. The connecting piece 223 may alternatively be of a connecting arm structure formed by disposing a groove on the base 21. Further, the connecting piece 223 is not specifically limited in this application.

It may be understood that compared with the transducer 22 in the foregoing implementations, the transducer 22 in this implementation does not include the support member 221. The transducer 22 in this implementation and the base 21 may form an integral structure. In this way, the transducer 22 in this implementation can save a structure of the support member 221, so that the transducer 22 and the base 21 are arranged more compactly and the sound generation apparatus 100 has a simpler structure.

For example, the transducer 22 and the base 21 may implement an integral structure by using a MEMS process.

It may be understood that the structural feature in this implementation may be combined with the sound generation apparatus 100 in the foregoing implementations. Details are not described herein again.

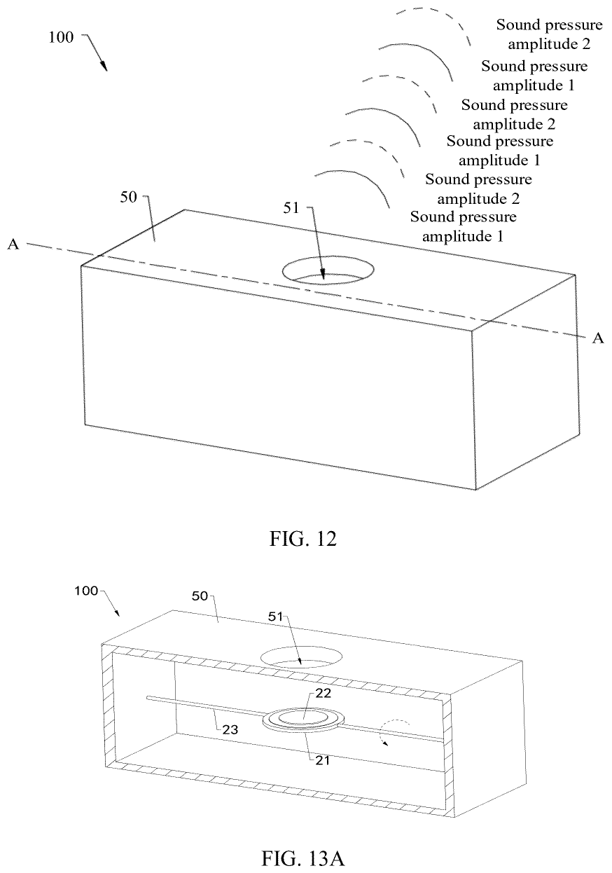

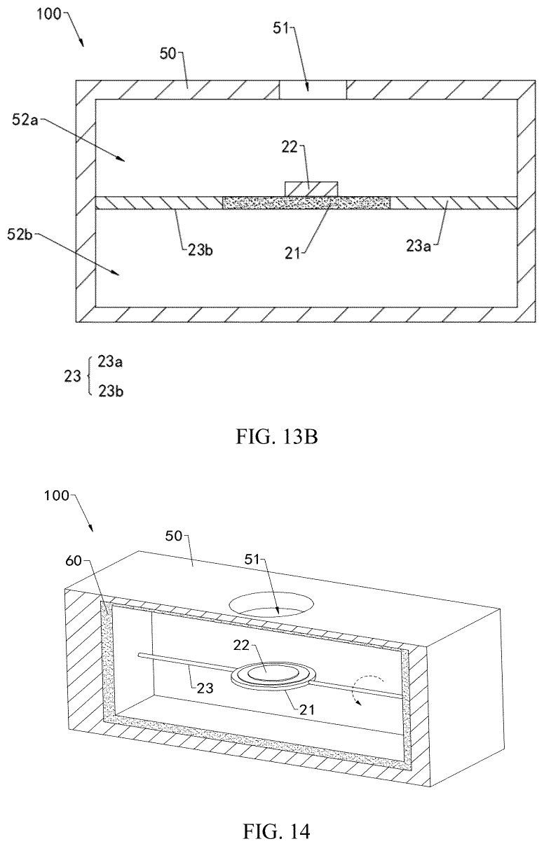

FIG. 12 is a diagram of a structure of the sound generation component 20 of the sound generation apparatus 100 shown in FIG. 2 in still another implementation. FIG. 13A is a partial cross-sectional view of an implementation of the sound generation component 20 shown in FIG. 12 along a line A-A.

As shown in FIG. 12 and FIG. 13A, in an implementation, the sound generation apparatus 100 further includes a casing 50. The casing 50 is provided with a sound outlet hole 51. The sound outlet hole 51 communicates with an inner cavity and external space of the casing 50. The sound outlet hole 51 may be located on a top part of the casing 50. In another implementation, a position of the sound outlet hole 51 is not specifically limited. For example, the sound outlet hole 51 may alternatively be located on a side part or a bottom part.

All of the base 21, the transducer 22, and the driving apparatus 23 are disposed in the inner cavity of the casing 50. The driving apparatus 23 may be connected to the casing 50. In addition, the implementations shown in FIG. 1 and FIG. 2 show that both the signal processing circuit 30 and the control circuit 40 are mounted inside the housing 10 of the headset 100. In this case, both the signal processing circuit 30 and the control circuit 40 are located in the external space of the casing 50. In another implementation, at least one of the signal processing circuit 30 and the control circuit 40 may alternatively be disposed in the inner cavity of the casing 50. In another implementation, a part of the signal processing circuit 30 is disposed in the inner cavity of the casing 50, and a part is disposed in the external space of the casing 50. In another implementation, a part of the control circuit 40 is disposed in the inner cavity of the casing 50, and a part is disposed in the external space of the casing 50.

It may be understood that the casing 50 may be a core structure of the sound generation apparatus 100. The casing 50 may be configured to provide isolation from, a connection to, and fastening to another part of the electronic device. In addition, the base 21, the transducer 22, and the driving apparatus 23 are packaged into an integral structure through the casing 50, to achieve good integrity of the sound generation apparatus 100. This facilitates adaptation to application of the sound generation apparatus 100 to an integrated machine, that is, facilitates arrangement of the sound generation apparatus 100 in the electronic device.

In addition, the sound outlet hole 51 is usually a through-hole structure or a pipe structure on the casing 50. The sound outlet hole 51 may conduct a sound wave emitted by the sound generation apparatus 100 to the external space of the casing 50, conduct the sound wave to a position of a sound output hole of the electronic device, and then conduct the sound wave to the outside of the electronic device through a sound outlet hole of the electronic device.

For example, the casing 50 may be an open casing, or there are closed structures at all positions other than the position of the sound outlet hole 51.

It may be understood that the structural feature in this implementation may be combined with the sound generation apparatus 100 in the foregoing implementations. Details are not described herein again.

FIG. 13B is a partial cross-sectional view of another implementation of the sound generation component 20 shown in FIG. 12 along a line A-A.

In an implementation, the driving apparatus 23 and the base 21 may divide the inner cavity of the casing 50 into a first inner cavity 52a and a second inner cavity 52b. The first inner cavity 52a communicates with the sound outlet hole 51. The audible sound generated by the sound generation apparatus 100 may be conducted to external space of the sound generation apparatus 100 through the first inner cavity 52a and the sound outlet hole 51.

For example, the driving apparatus 23 is described by using the structure shown in FIG. 3 as an example. The first piezoelectric driving mechanism 23a, the second piezoelectric driving mechanism 23b, and the base 21 divide the inner cavity of the casing 50 into the first inner cavity 52a and the second inner cavity 52b.

It may be understood that the structural feature in this implementation may be combined with the sound generation apparatus 100 in the foregoing implementations. Details are not described herein again.

FIG. 14 is a diagram of a structure of the sound generation component 20 of the sound generation apparatus 100 shown in FIG. 2 in still another implementation.

As shown in FIG. 14, in an implementation, the sound generation apparatus 100 further includes a sound-absorbing part 60. The sound-absorbing part 60 may be a sound-absorbing material (for example, sound-absorbing cotton), a sound-absorbing structure (for example, a micro-perforated panel), or the like.

The sound-absorbing part 60 is disposed on an inner surface of the casing 50 and disposed in a staggered manner with the sound outlet hole 51. For example, the sound-absorbing part 60 may be connected to the inner surface of the casing 50 through filling, attaching, or the like. In addition, the sound-absorbing part 60 may completely cover the inner surface of the casing 50, or may partially cover the inner surface of the casing 50.

The sound-absorbing part 60 is mounted in a manner. For example, the sound-absorbing part 60 may be of a plate structure or a layered structure. In some implementations, the sound-absorbing part 60 may be fastened to a bottom wall of the housing, and the sound-absorbing part 60 completely or partially covers a region of the bottom wall. In some other manners, the sound-absorbing part 60 may alternatively be fastened to a side wall of the housing, to increase a sound-absorbing area of the sound-absorbing part 60. In some other embodiments, the sound-absorbing part 60 may alternatively be a three-dimensional structural member, and is fastened to a top part of the transducer 22. It may be understood that a specific spacing is formed between the sound-absorbing part 60 and the vibration member 222, and space corresponding to the spacing is used as vibration space of the vibration member 222, to avoid interference caused by the sound-absorbing part 60 to vibration of the vibration member 222.

It may be understood that the sound-absorbing part 60 is disposed on the inner surface of the casing 50, and the sound-absorbing part 60 may absorb a sound wave propagated to the inner surface of the casing 50, to reduce reflection of the sound wave in the casing 50 and reduce distortion of an audible sound.

It may be understood that the structural feature in this implementation may be combined with the sound generation apparatus 100 in the foregoing implementations. Details are not described herein again.

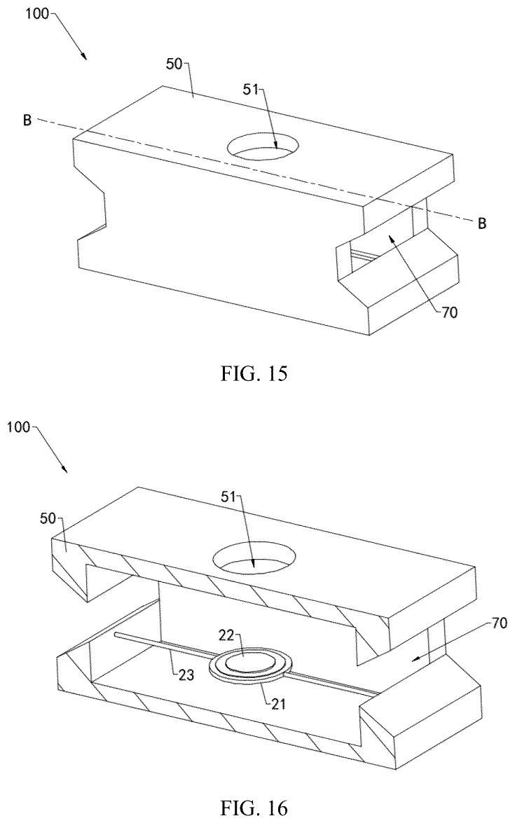

FIG. 15 is a diagram of a structure of the sound generation component 20 of the sound generation apparatus 100 shown in FIG. 2 in still another implementation. FIG. 16 is a partial cross-sectional view of an implementation of the sound generation component 20 shown in FIG. 15 along a line B-B.

As shown in FIG. 15 and FIG. 16, in an implementation, the casing 50 is provided with a sound wave guiding structure 70. The sound wave guiding structure 70 is disposed at an interval from the sound outlet hole 51. The sound wave guiding structure 70 may communicate the inner cavity of the casing 50 with the external space of the casing 50. The sound wave guiding structure 70 may be a structure such as a hole or a pipe.

It may be understood that the sound wave guiding structure 70 may be configured to export a sound wave in the inner cavity of the casing 50 to the external space of the casing 50. In this way, the sound wave guiding structure 70 may be configured to implement atmospheric pressure balance between the inner cavity of the casing 50 and the outside of the casing 50, so that the transducer 22 can smoothly vibrate, and a sound wave with a small distortion degree is formed under driving of the first control signal.

In an implementation, when the sound generation apparatus 100 is used in the electronic device, the sound wave guiding structure 70 does not communicate with the sound outlet hole of the electronic device, that is, the sound wave guiding structure 70 is not used as a main sound outlet channel of the electronic device.

In an implementation, an extension direction of the sound wave guiding structure 70 is different from an extension direction of the sound outlet hole 51 of the casing 50. For example, when the sound outlet hole 51 is disposed on the top part of the casing 50, the sound wave guiding structure 70 may be disposed on the side part or the bottom part of the casing 50. In this way, the sound wave guiding structure 70 may be disposed away from the sound outlet hole 51.

In an implementation, an extension direction of the sound wave guiding structure 70 is opposite or perpendicular to an extension direction of the sound outlet hole 51 of the casing 50. For example, when the sound outlet hole 51 is disposed on the top part of the casing 50, the sound wave guiding structure 70 may be disposed on the side part or the bottom part of the casing 50.

It may be understood that a position of the sound wave guiding structure 70 on the casing 50 is not specifically limited in this application. For example, the position of the sound wave guiding structure 70 on the casing 50 may be set based on a structure of an actual electronic device. In addition, the sound wave guiding structure 70 is not limited to two structures shown in FIG. 15. In another implementation, a quantity of sound wave guiding structures 70 is not limited. For example, the quantity of sound wave guiding structures 70 may be determined based on factors such as a radiation sound pressure level and a rotation angle of the vibration member 222 of the sound generation apparatus 100.

In an implementation, a minimum width of the sound wave guiding structure 70 is greater than a thickness d_{μ} of a viscous layer, and the thickness d_{μ} of the viscous layer satisfies:

$${d}_{μ} = 0.22 mm \times \sqrt{\frac{100 Hz}{{f}_{1}}} ,$$

where f is a frequency at which the transducer 22 emits the first sound wave.

It may be understood that the minimum width of the sound wave guiding structure 70 is a dimension at a narrowest position of a single sound wave guiding structure 70. For example, when the sound wave guiding structure 70 is a hole structure, a minimum width of a hole is a dimension at a narrowest position of a single hole.

In another implementation, a size of the sound wave guiding structure 70 is not specifically limited. For example, the size of the sound wave guiding structure 70 may also be determined based on factors such as the radiation sound pressure level and the rotation angle of the vibration member 222 of the sound generation apparatus.

In an implementation, the sound generation apparatus 100 may be further provided with a damping mesh fabric (not shown in the figure), and the damping mesh fabric may be fastened to the casing 50 through bonding or in another manner, and covers the sound wave guiding structure 70. The damping mesh fabric is breathable, to achieve atmospheric pressure balance between the inner cavity of the casing 50 and the outside of the casing 50. In addition, the damping mesh fabric can implement acoustic isolation for the atmospheric pressure balance between the inner cavity of the casing 50 and the outside of the casing 50, and can reduce leakage of a sound wave in the inner cavity 52 to the outside of the fastening casing 50a. Breathability means that media on two sides of an interface can be exchanged, and acoustic isolation means to reduce or isolate leakage of sound wave energy. A quantity, shapes, and the like of damping mesh fabrics are adapted to a front discharge hole. In some other embodiments, the sound generation apparatus 100 may not be provided with the second damping mesh fabric.

It may be understood that the structural feature in this implementation may be combined with the sound generation apparatus 100 in the foregoing implementations. Details are not described herein again.

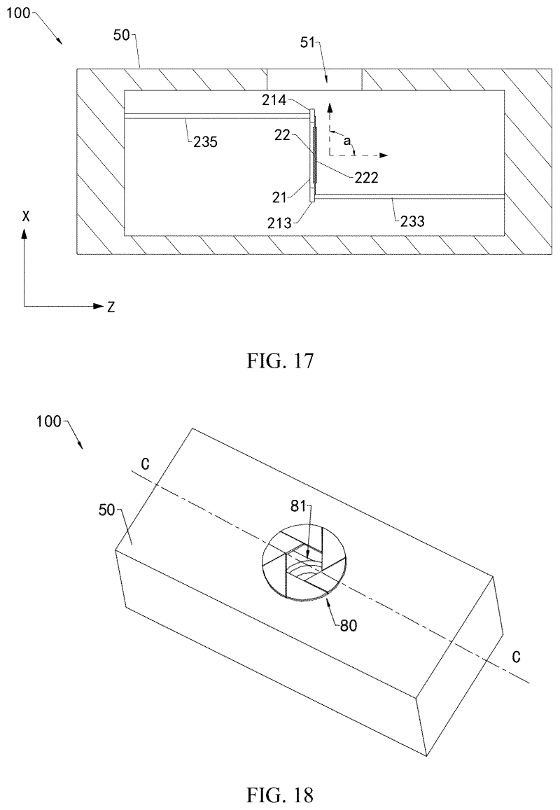

FIG. 17 is a diagram of a structure of the sound generation component 20 of the sound generation apparatus 100 shown in FIG. 2 in still another implementation.

As shown in FIG. 17, in an implementation, an included angle between an axial direction of the vibration member 222 of the transducer 22 and an extension direction of the sound outlet hole 51 is a; and a satisfies: 45°% a≤135°. For example, a is equal to 45°, 60°, 90°, 100°, 120°, or 135°. FIG. 17 shows that a is equal to 90°. It may be understood that the axial direction of the vibration member 222 is a direction perpendicular to a plane on which the vibration member 222 is located.

It may be understood that with reference to FIG. 7, compared with the main lobe energy of the ultrasonic wave in the space being in a positive “8” shape, main lobe energy of the audible sound in the space is approximately in an inverted “8” shape. At the defined coordinates, the audible sound in this implementation has a highest sound pressure level in the direction of the X-axis. Therefore, a is set to satisfy 45°% a≤135°, so that a direction at a higher sound pressure level in the audible sound faces the sound outlet hole 51 of the casing 50. In this case, a sound pressure level of an audible sound transmitted out of the casing 50 is higher. It may be understood that when a is equal to 90°, a direction at a highest sound pressure level in the audible sound faces the sound outlet hole 51 of the casing 50. In this way, the sound pressure level of the audible sound transmitted out of the casing 50 can be highest.

In another implementation, an included angle α between an axial direction of the vibration member 222 of the transducer 22 and an extension direction of the sound outlet hole 51 is not specifically limited. For example, a value of a affects a sound pressure level and directivity of the audible sound. Therefore, a design may be made based on an actual architecture.

It may be understood that an example in which the driving apparatus 23 in FIG. 3 is used in the driving apparatus 23 shown in FIG. 17 is used for description. When the first cantilever 233 drives the first side 213 of the base 21 to vibrate in the positive direction of the Z-axis(that is, a right side in FIG. 17), and the second cantilever 234 drives the second side 214 of the base 21 to vibrate in the negative direction of the Z-axis(that is, a left side in FIG. 17), the base 21 rotates counterclockwise relative to the virtual rotating shaft G1. In this case, in a process in which the base 21 drives the transducer 21 to rotate, the angle a becomes larger. When the first cantilever 233 drives the first side 213 of the base 21 to vibrate in the negative direction of the Z-axis(that is, a left side in FIG. 17), and the second cantilever 234 drives the second side 214 of the base 21 to vibrate in a positive direction of the Z-axis(that is, a right side in FIG. 17), the base 21 rotates clockwise relative to the virtual rotating shaft G1. In this case, in a process in which the base 21 drives the transducer 21 to rotate, the angle a becomes smaller.

It may be understood that an example in which the driving apparatus 23 in FIG. 8 is used in the driving apparatus 23 shown in FIG. 17 is used for description. With reference to FIG. 8 and FIG. 17, the first output shaft 235 of the first motor 23c and the second output shaft 236 of the second motor 23d are respectively connected to the two sides of the base 21. The first output shaft 235 and the second output shaft 236 may be parallel to the Y-axis (a direction perpendicular to a paper surface). In this case, the base 21 may drive the transducer 22 to perform reciprocating rotation or continuous rotation. Reciprocating rotation is used as an example for description. The first output shaft 235 and the second output shaft 236 may first drive the base 21 and the transducer 22 to rotate in the negative direction of the Z-axis(that is, a left side in FIG. 17), and then drive the base 21 and the transducer 22 to rotate in the positive direction of the Z-axis(that is, a right side in FIG. 17).

It may be understood that an example in which the driving apparatus 23 in FIG. 10 is used in the driving apparatus 23 shown in FIG. 17 is used for description. With reference to FIG. 10 and FIG. 17, the telescopic arm 238 of the telescopic mechanism 23e may perform extension and retraction motion to drive the base 21 to perform reciprocal motion in the direction of the X-axis or the direction of the Y-axis (a direction perpendicular to a paper surface). In this implementation, in a process in which the base 21 drives the transducer 21 to perform reciprocating translation in the direction of the X-axis or the direction of the Y-axis, the angle a remains unchanged.

In an implementation, the transducer 22 may be disposed as close as possible to the sound outlet hole 51, so that the vibration member 222 of the transducer 22 may be disposed close to the sound outlet hole 51 to a large extent. In this way, most of the audible sound may be propagated to the outside of the sound generation apparatus 100 through the sound outlet hole 51.

It may be understood that the structural feature in this implementation may be combined with the sound generation apparatus 100 in the foregoing implementations. Details are not described herein again.

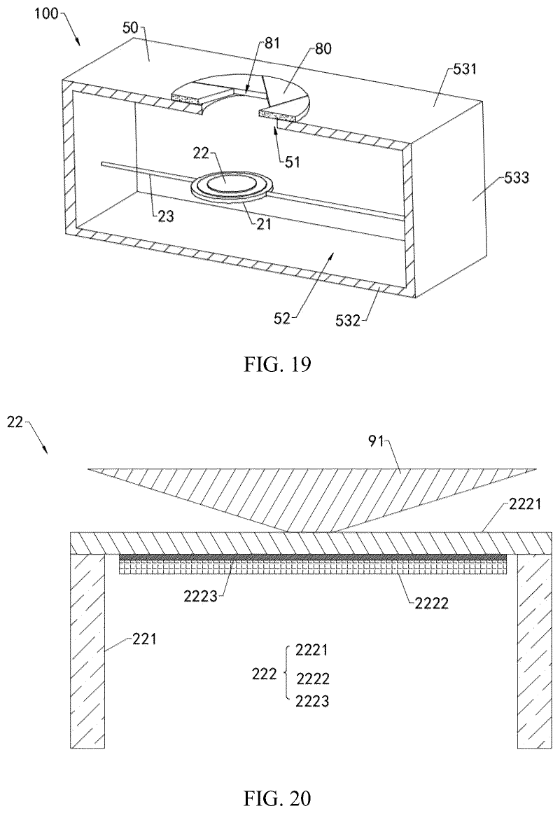

FIG. 18 is a diagram of a structure of the sound generation component 20 of the sound generation apparatus 100 shown in FIG. 2 in still another implementation. FIG. 19 is a partial cross-sectional view of an implementation of the sound generation component 20 shown in FIG. 18 along a line C-C.

As shown in FIG. 18 and FIG. 19, in an implementation, the sound generation apparatus 100 further includes an adjustment mechanism 80. The adjustment mechanism 80 has a first sound output hole 81. A size of the first sound output hole 81 is capable of becoming larger or smaller.

For example, the adjustment mechanism 80 includes a plurality of blades. The plurality of blades jointly enclose the first sound output hole 81. An aperture of the first sound output hole 81 is adjusted by controlling motion of the plurality of blades, to increase or decrease the size of the first sound output hole 81.

As shown in FIG. 18 and FIG. 19, the adjustment mechanism 80 is disposed on the casing 50. The first sound output hole 81 of the adjustment mechanism 80 communicates with the sound outlet hole 51 of the casing 50. In this case, the audible sound generated by the sound generation apparatus 100 may be transmitted to the outside of the sound generation apparatus 100 through the sound outlet hole 51 of the casing 50 and the first sound output hole 81 of the adjustment mechanism 80.

It may be understood that when the size of the first sound output hole 81 of the adjustment mechanism 80 becomes larger, an area of a channel in which the audible sound is conducted is large. In this way, the audible sound is not prone to diffraction at the first sound output hole 81. Therefore, directivity of the audible sound conducted to the casing 50 is not prone to change. When the size of the first sound output hole 81 of the adjustment mechanism 80 becomes smaller, an area of a channel in which the audible sound is conducted is small. In this way, the audible sound is prone to diffraction at the first sound output hole 81. Therefore, directivity of the audible sound conducted to the casing 50 is prone to change.

It may be understood that when low-frequency directivity is required, an area of the first sound output hole 81 is increased. A suitable scenario herein may be that the sound generation apparatus 100 plays a sound in a specific direction or toward a specific user. For example, in a private call scenario, when a user makes a call and does not want another person to hear a downlink sound of the call, the aperture of the first sound output hole 81 is adjusted to be larger, and the sound has directivity, so that the sound is emitted only toward the user and cannot be heard by a surrounding person. For another example, in a music exclusive scenario, when another person rests around and a user wants to enjoy audio and video entertainment, the aperture of the first sound output hole 81 is adjusted to be larger, and the sound has directivity, so that the sound is emitted only toward the user and cannot be heard by a surrounding person, so as not to disturb the surrounding person.

When low-frequency directivity is not required, an area of the first sound output hole 81 is decreased. A suitable scenario herein may be that the sound generation apparatus 100 plays a sound toward users in a plurality of directions. For example, when people around a user want to listen to the sound together, the first sound output hole 81 may be adjusted to be smaller, and the audible sound has no directivity, so that all people around the user can hear the sound.

In another implementation, the adjustment mechanism 80 may alternatively be a mobile blocking part. The mobile blocking part may selectively block the sound outlet hole 51, or change a size for blocking the sound outlet hole 51, to change a size of the sound outlet hole 51. Further, a specific structure of the adjustment mechanism 80 is not limited in this application.

It may be understood that the structural feature in this implementation may be combined with the sound generation apparatus 100 in the foregoing implementations. Details are not described herein again.

FIG. 20 is a diagram of a structure of an ultrasonic transducer 22 in some embodiments according to an embodiment of this application.

As shown in FIG. 20, in some embodiments, the transducer 22 may be a piezoelectric ultrasonic transducer. The transducer 22 includes a support member 221 and a vibration member 222. The vibration member 222 includes a diaphragm 2221 and a piezoelectric sheet 2222. A peripheral edge of the diaphragm 2221 is fastened to the support member 221, and the piezoelectric sheet 2222 is fastened to the diaphragm 2221. For example, the piezoelectric sheet 2222 includes a piezoelectric material layer. In this case, the ultrasonic transducer 22 is a piezoelectric single crystal ultrasonic transducer 22. The piezoelectric material layer may be made of a piezoelectric material such as lead zirconate titanate (PZT) piezoelectric ceramics. The piezoelectric sheet 2222 may be bonded to the diaphragm 2221 through an adhesive layer 2223. The piezoelectric sheet 2222 may be located on an upper surface or a lower surface of the diaphragm 2221. This is not strictly limited in this embodiment of this application. The diaphragm 2221 may be made of a material such as aluminum. In this embodiment, because of a high Q value characteristic of the piezoelectric sheet 2222, the ultrasonic transducer 22 has high energy conversion efficiency. A Q value is referred to as a quality factor, and a high Q value means a low sound wave energy loss (an attenuation ratio is directly proportional to a square of a frequency).

By adjusting a material and a geometric dimension of the ultrasonic transducer 22, a resonance frequency of the vibration member 222 of the ultrasonic transducer 22 can be adjusted, so that the resonance frequency falls within a desired frequency range. For example, the resonance frequency of the vibration member 222 is designed to be 40 kHz, to be applicable to a sound generation apparatus 100 that needs to form a medium- or low-frequency audible sound. An example in which the piezoelectric sheet 2222 is of a circular sheet structure is used for description. The piezoelectric material is PZT-5H, and a polarization direction is a thickness direction of the piezoelectric sheet 2222. A voltage is applied to upper and lower surfaces of the piezoelectric sheet 2222. The piezoelectric sheet 2222 has a radius of 4 mm and a thickness of 0.8 mm. The diaphragm 2221 is made of aluminum and has a thickness of 0.2 mm. In this case, the resonance frequency of the vibration member 222 is 40 kHz or close to 40 kHz.

In some implementations, the resonance frequency of the vibration member 222 may be increased by reducing an area of the piezoelectric sheet 2222, and/or increasing the thickness of the piezoelectric sheet 2222, and/or increasing a thickness of the material of the diaphragm 2221, and/or increasing hardness of the material of the diaphragm 2221, so that the resonance frequency matches a frequency of a desired initial ultrasonic wave. A specific solution may be designed based on an actual requirement. Details are not described herein again.

It may be understood that the structural feature in this implementation may be combined with the sound generation apparatus 100 in the foregoing implementations. Details are not described herein again.

As shown in FIG. 20, in some implementations, a phase of a sound wave emitted by the vibration member 222 is focused. For example, the phase q(r) of the sound wave emitted by the vibration member 222 satisfies:

$$φ ( r ) = \frac{2 π * ( \sqrt{{f}^{2} + {r}^{2}} - f )}{λ}$$

Herein, r is a distance between any point on a surface of the vibration member 222 and a center of the vibration member 222, 1 is a wavelength corresponding to the sound wave emitted by the vibration member 222, and f is a focal length corresponding to the sound wave emitted by the vibration member 222.

It may be understood that when the phase q(r) of the sound wave emitted by the vibration member 222 satisfies the foregoing relational expression, the phase of the sound wave emitted by the vibration member 222 may be focused, to enhance directivity of the sound wave emitted by the diaphragm 2221 and increase a sound pressure level of the audible sound.

It may be understood that there is a plurality of solutions for focusing the phase φ(r) of the sound wave emitted by the vibration member 222. In an implementation, a shape of the vibration member 222 may be set (for example, the surface of the vibration member 222 may be set to be in a shape similar to that of a surface of a convex lens or a shape similar to that of a surface of a Fresnel lens), to implement a focusing design of the phase q(r) of the sound wave emitted by the vibration member 222. In another implementation, a focusing structure (for example, the following sound wave directing member 91) may alternatively be disposed on the surface of the vibration member 222, and the focusing structure may implement a focusing design of the phase φ(r) of the sound wave emitted by the vibration member 222.

As shown in FIG. 20, in some implementations, the transducer 22 may further include a sound wave directing member 91. The sound wave directing member 91 is located above the vibration member 222, and the sound wave directing member 91 is configured to limit a radiation direction of an ultrasonic wave generated by the ultrasonic transducer 22, to enhance the directivity of the sound wave emitted by the diaphragm 2221 and increase the sound pressure level of the audible sound. The sound wave directing member 91 may include an emission surface. The emission surface is in a conical shape. The conical emission surface can narrow the directivity of the initial ultrasonic wave to approximately 60°, to greatly enhance the directivity of the sound wave emitted by the diaphragm 2221.

It may be understood that the structural feature in this implementation may be combined with the sound generation apparatus 100 in the foregoing implementations. Details are not described herein again.

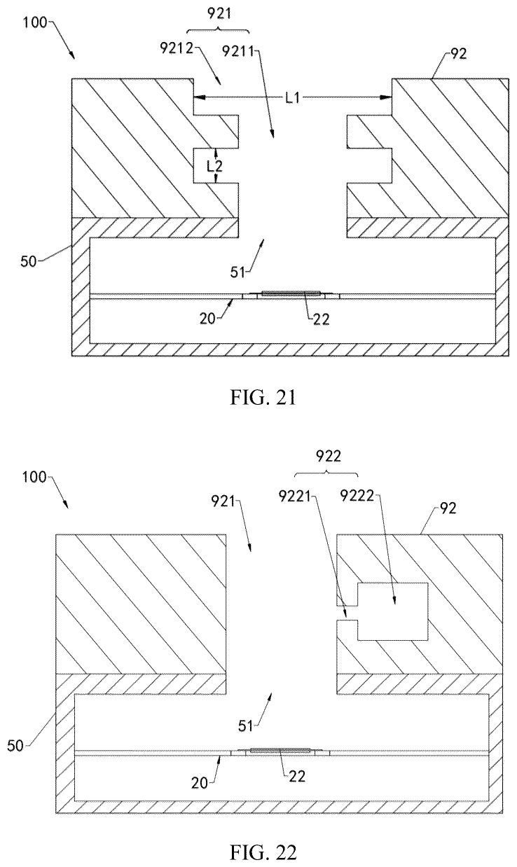

FIG. 21 is a schematic cross-sectional view of the sound generation component 20 of the sound generation apparatus 100 shown in FIG. 2 in still another implementation. FIG. 22 is a schematic cross-sectional view of the sound generation component 20 of the sound generation apparatus 100 shown in FIG. 2 in still another implementation.

As shown in FIG. 21 and FIG. 22, in some implementations, the sound generation apparatus 100 further includes a front cavity filter 92. The front cavity filter 92 has a second sound output hole 921. The front cavity filter 92 is fastened to the casing 50, and the second sound output hole 921 communicates with the sound outlet hole 51 of the casing 50. In some implementations, the front cavity filter 92 may be fastened to the casing 50 by using adhesive or in another manner. In some implementations, the front cavity filter 92 and the casing 50 may alternatively form an integral structural member.

In this implementation, the front cavity filter 92 may be configured to filter out a non-target sound wave. In other words, the non-target sound wave cannot pass through the front cavity filter 92. A target sound wave may pass through the front cavity filter 92.

It may be understood that the transducer 22 emits the first sound wave at a frequency of f₁ under the driving of the first control signal. In addition, the base 21 moves at a frequency of f₂ under the driving of the second control signal. In this case, a sound field in the space changes, and modulation is generated to form an audible sound. The sound field in the space includes two sound wave frequencies: |f₁+f₂| and |f₁−f₂|. One of sound waves at the two frequencies in the space may be filtered out, to leave a sound wave at one frequency. For example, a sound wave at the frequency of |f₁+f₂| is filtered out, to retain a sound wave at |f₁−f₂|. In this case, a frequency of the target sound wave is |f₁−f₂|, and a frequency of the non-target sound wave is |f₁+f₂|. In this implementation, the front cavity filter 92 may be configured to: filter out the non-target sound wave, that is, the sound wave at the frequency of |f₁+f₂|, and pass the sound wave at the frequency of |f₁−f₂l.

In an implementation, the non-target sound wave is a high-frequency sound wave, and the target sound wave is a low-frequency sound wave. In other words, the front cavity filter 92 may be configured to filter out the high-frequency sound wave, so that the low-frequency sound wave passes through the front cavity filter 92. For example, an example in which f₁=40 KHz and f₂=41 KHz is used for description. The front cavity filter 92 may be configured to: pass a sound wave at a frequency of |f₁−f₂|=1 KHz, and filter out a sound wave at a frequency of |f₁+f₂|=41 KHz. In other words, the high-frequency sound wave (41 KHz) may be dissipated in the front cavity filter 92 due to thermal viscosity and other effects. In this case, the high-frequency sound wave (41 KHz) cannot be propagated to the outside of the sound generation apparatus 100.

The following describes several specific structures of the front cavity filter 92 with reference to related accompanying drawings.

As shown in FIG. 21, a hole wall of the second sound output hole 921 is of a variable cross-sectional structure, that is, the front cavity filter 92 is a variable cross-sectional pipe. For example, the second sound output hole 921 of the front cavity filter 92 includes a plurality of narrow regions 9211 and a plurality of wide regions 9212. The plurality of narrow regions 9211 and the plurality of wide regions 9212 are alternately arranged. In this case, the hole wall of the second sound output hole 921 of the front cavity filter 92 is approximately of a concave-convex structure. It may be understood that a width of the narrow region 9211 is less than a width of the wide region 9212. Widths of all the narrow regions 9211 may not be strictly equal. Widths of all the wide regions 9212 may not be strictly equal.

As shown in FIG. 21, the width L1 of the wide region 9212 falls within a range of 0.1 mm to 50 mm. In addition, a distance L2 (that is, a height of the wide region 9212) between two adjacent narrow regions 9211 is greater than 0.1 mm. It may be understood that a frequency of a sound wave filtered out by the front cavity filter 92 is related to both the width L1 of the wide region 9212 and the distance L2 between two adjacent narrow regions 9211. An example in which f₁=40 KHz and f₂=41 KHz is used for description. The sound wave at |f₁+f₂|=41 KHz needs to be filtered out, and corresponds to a wavelength of 10=8.4 mm in the air. If the width L1 of the wide region 9212 may be set to 2.5 mm, and the distance L2 between two adjacent narrow regions 9211 is set to 2 mm, a sound pressure level may be decreased by more than 20 dB after the sound wave at 41 KHz passes through the second sound output hole 921.

As shown in FIG. 22, the second sound output hole (921) has an acoustic Helmholtz resonator. In this case, the front cavity filter 92 has a resonant cavity 922. The resonant cavity 922 communicates with the second sound output hole 921. In this way, the front cavity filter 92 may be configured to: filter out the high-frequency sound wave, and pass the low-frequency sound wave. It may be understood that the resonant cavity 922 is not limited to one cavity shown in FIG. 22, and there may be a plurality of resonant cavities 922. The plurality of resonant cavities 922 may differ in dimension.

The resonant cavity 922 includes a first cavity 9221 and a second cavity 9222. A cross-sectional width of the first cavity 9221 is less than a cross-sectional width of the second cavity 9222. The first cavity 9221 communicates with the second sound output hole 921.

For example, a characteristic length of the first cavity 9221 is greater than 0.01 mm, and a characteristic length of the second cavity 9222 falls within a range of 0.1 mm to 50 mm. It may be understood that the characteristic length of the first cavity 9221 means a distance between two farthest points in the first cavity 9221. For example, the first cavity 9221 is spherical, and the characteristic length of the first cavity 9221 is a diameter of the sphere. For another example, the first cavity 9221 is cylindrical, and the characteristic length of the first cavity 9221 is a height of the cylinder or the like. In addition, the characteristic length of the second cavity 9222 means a distance between two farthest points in the second cavity 9222. For an example of the characteristic length of the second cavity 9222, refer to the example of the characteristic length of the first cavity 9221. Details are not described herein again.

It may be understood that a frequency of a sound wave filtered out by the front cavity filter 92 is related to both the characteristic length of the first cavity 9221 and the characteristic length of the second cavity 9222. An example in which f₁=40 KHz and f₂=41 KHz is used for description. The sound wave at |f₁+f₂|=41 KHz needs to be filtered out, and corresponds to a wavelength of 20=8.4 mm in the air. If a diameter of the second sound output hole 921 is 1 mm, the characteristic length of the first cavity 9221 may be set to 0.5 mm, and the characteristic length of the second cavity 9222 may be set to 4.5 mm. In this way, a sound pressure level may be decreased by more than 20 dB after the sound wave 41 KHz passes through the second sound output hole 921.

In another implementation, the front cavity filter 92 may alternatively use another pipe or cavity structure. The pipe or cavity may satisfy a principle such as pipe resonance and transmission. In this way, the front cavity filter 92 may be configured to: filter out the high-frequency sound wave, and pass the low-frequency sound wave.

In another implementation, the front cavity filter 92 may alternatively use another low-pass structure or another band-stop structure.

It may be understood that the structural feature in this implementation may be combined with the sound generation apparatus 100 in the foregoing implementations. For example, when this implementation is combined with the implementations in FIG. 18 and FIG. 19, the adjustment mechanism 80 may be located on a top part of the front cavity filter 92. The first sound output hole 81 of the adjustment mechanism 80 communicates with the second sound output hole 921 of the front cavity filter 92. Details are not described herein again.

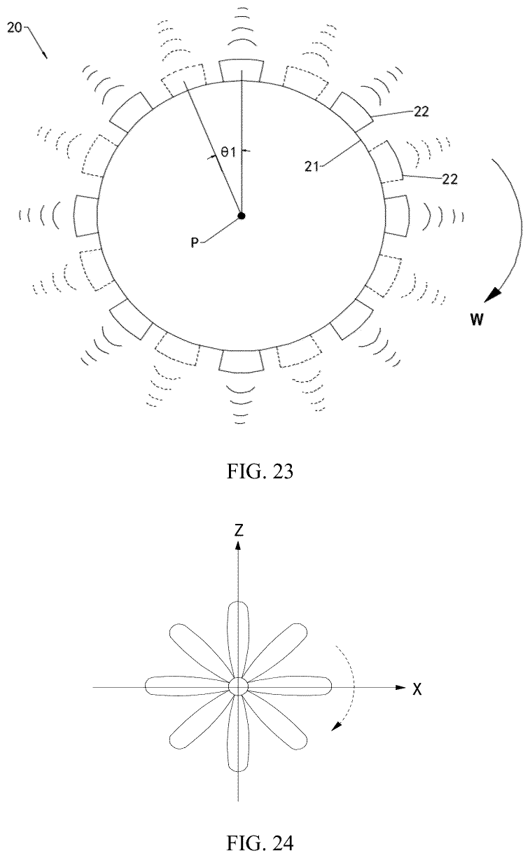

FIG. 23 is a diagram of a structure of the sound generation component 20 of the sound generation apparatus 100 shown in FIG. 2 in still another implementation. FIG. 24 is a diagram of energy distribution of a main lobe of a first sound wave emitted by a plurality of transducers 22 shown in FIG. 23.

As shown in FIG. 23 and FIG. 24, in some implementations, there are a plurality of transducers 22. The plurality of transducers 22 are arranged on the base 21 at an interval in a rotation direction. In this way, when the driving apparatus 23 drives the base 21 to rotate, the base 21 drives the plurality of transducers 22 to rotate around a rotating shaft (shown by using a point P in FIG. 23).

It may be understood that when the rotation angle θ of the base 21 is equal to 0°, the plurality of transducers 22 emit the first sound wave at the frequency of f₁ under the driving of the first control signal. FIG. 23 schematically shows the transducer 22 and a conduction direction of the first sound wave when θ=0° through a curved solid line. When the rotation angle θ of the base 21 is equal to θ1 (θ1 >0 or θ1≤0), the plurality of transducers 22 also emit the first sound wave at the frequency of f₁ under the driving of the first control signal. FIG. 23 schematically shows the transducer 22 and a conduction direction of the first sound wave when θ=0° through a curved dashed line. In a process in which the plurality of transducers 22 perform reciprocating rotation, the sound pressure amplitude of the first sound wave reciprocally changes. In this case, the first sound wave is modulated to form the second sound wave. The second sound wave may include an audible sound. It may be understood that because the plurality of transducers 22 are arranged on the base 21 at an interval in the rotation direction, in a rotation process of the plurality of transducers 22, each transducer 22 may pass through a position of another transducer 22. In this way, the first sound wave jointly emitted by the plurality of transducers 22 has a plurality of side lobes or a plurality of beams. Each side lobe may be used as a main lobe shown in FIG. 7. In this way, a requirement for a rotation frequency can be greatly lowered. For example, if there are n transducers 22 and n side lobes, an equivalent rotation frequency of the n side lobes in a rotation process is n×f. Therefore, the n side lobes can reduce the rotation frequency to f₂/n.

In an implementation, the base 21 is cylindrical. The plurality of transducers 22 are fastened on an outer surface of the cylindrical base 21 at an interval. The driving apparatus 23 may be a motor. An output shaft of the motor is connected to a top surface or a bottom surface of the cylindrical base 21. For example, the output shaft of the motor may be parallel to a central axis of the cylindrical base 21. In this way, when the output shaft of the motor rotates, the output shaft of the motor may drive the cylindrical base 21 to drive the plurality of transducers 22 to rotate.

In another implementation, a plurality of side lobes or a plurality of beams may alternatively be disposed by using another acoustic multipole structure.

It may be understood that the structural feature in this implementation may be combined with the sound generation apparatus 100 in the foregoing implementations. Details are not described herein again.

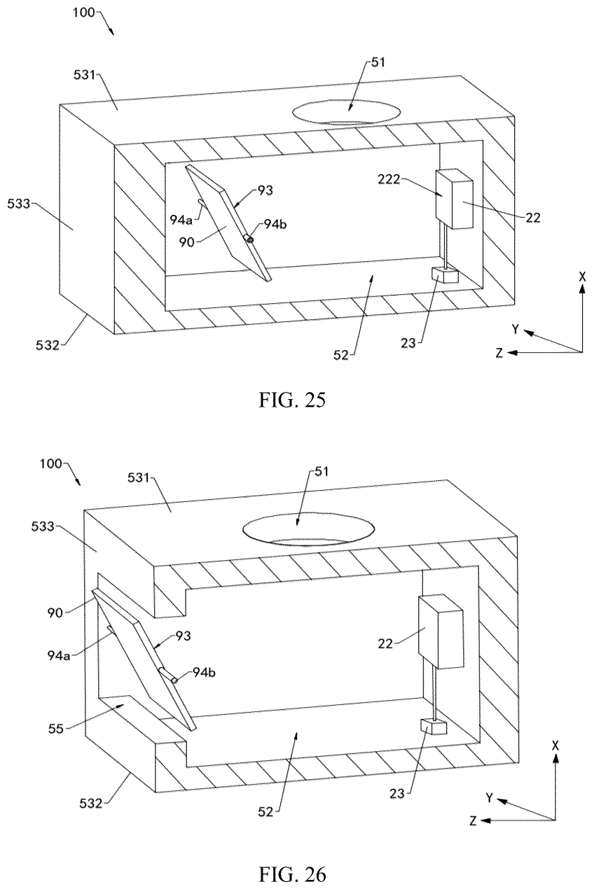

FIG. 25 is a diagram of a structure of the sound generation component 20 of the sound generation apparatus 100 shown in FIG. 2 in still another implementation.

As shown in FIG. 25, the sound generation apparatus 100 further includes a reflector 90. The reflector 90 has a reflective surface 93.

In addition, the reflector 90 is disposed at an interval from the transducer 22. The reflective surface 93 of the reflector 90 faces the vibration member 222 of the transducer 22. It may be understood that the transducer 22 is disposed to emit the first sound wave at the frequency of f₂ to the outside while performing periodic motion at the frequency of f₁. In this case, in a process in which the transducer 22 performs periodic motion, the sound pressure amplitude of the first sound wave periodically changes. The first sound wave may be modulated to form the second sound wave. After being reflected by the reflector 90, the second sound wave may be transmitted to the external space of the casing 50 through the sound outlet hole 51. Therefore, the reflector 90 in this implementation may be configured to adjust a propagation angle of the second sound wave. In this way, the position of the sound outlet hole 51 may be more flexibly set. As shown in FIG. 25, when the transducer 22 performs reciprocating rotation at the frequency of f₂, the first sound wave propagated in the positive direction of the Z-axis may be reflected for propagation in the direction of the X-axis.

FIG. 26 is a diagram of a structure of the sound generation component 20 of the sound generation apparatus 100 shown in FIG. 2 in still another implementation.

As shown in FIG. 26, in an implementation, the casing 50 is provided with a mounting hole 55. The mounting hole 55 communicates with the inner cavity 52 and the external space of the casing 50. The mounting hole 55 is disposed in a staggered manner with the sound outlet hole 51. For example, the sound outlet hole 51 is disposed on a top wall 531 of the casing 50. The mounting hole 55 is disposed on a side wall 533 of the casing 50.

The reflector 90 is fixedly connected to a hole wall of the mounting hole 55.

For example, the reflector 90 includes a first fixed shaft 94a and a second fixed shaft 94b. The first fixed shaft 94a and the second fixed shaft 94b are convexly disposed on two side faces that are disposed facing away from each other. Both the first fixed shaft 94a and the second fixed shaft 94b are fixedly connected to the hole wall of the mounting hole 55. In another implementation, the first fixed shaft 94a and the second fixed shaft 94b may pass through the reflector 90, and are connected to form a rotating shaft.

In an implementation, a part of the reflector 90 is located in the inner cavity 52 of the casing 50, a part is located in the mounting hole 55, and a part is located in the external space of the casing 50. In this way, the reflector 90 may use space of the mounting hole 55 and the external space of the casing 50 to a large extent, to facilitate miniaturization of the sound generation apparatus. In addition, the reflector 90 may avoid a component in the inner cavity 52 of the casing 50 to a large extent, to avoid interference between the reflector 90 and another component in a rotation process.

The sound generation apparatus 100 is described in detail above with reference to related accompanying drawings. The following schematically provides some transducers 22 that can emit ultrasonic waves. The following transducer 22 is referred to as an ultrasonic transducer.

In some embodiments, the ultrasonic transducer may alternatively be a polyvinylidene difluoride (PVDF) piezoelectric film ultrasonic transducer. The vibration member of the ultrasonic transducer is a polyvinylidene difluoride piezoelectric film. The polyvinylidene difluoride piezoelectric film may implement ultrasonic wave emission on a curved surface or a plane by using a simple constraint method, and a frequency is high. A resonance frequency of the vibration member usually falls within a range of 1 megahertz (MHz) to 100 MHz. In this case, the vibration member of the ultrasonic transducer can easily obtain a resonance frequency greater than 400 kHz. Certainly, in some other embodiments, the resonance frequency of the vibration member of the ultrasonic transducer may alternatively be another resonance frequency, for example, less than 400 kHz.

In some other embodiments, the ultrasonic transducer may alternatively be a micromachined ultrasonic transducer (MUT). For example, the ultrasonic transducer may be a capacitive micromachined ultrasonic transducer (CMUT) or a piezoelectric MUT (PMUT). The resonance frequency of the vibration member of the ultrasonic transducer in this embodiment is usually high, for example, may be greater than or equal to 400 kHz. Certainly, in some other embodiments, the resonance frequency of the vibration member of the ultrasonic transducer may alternatively be less than 400 kHz.

Both the capacitive micromachined ultrasonic transducer and the piezoelectric micromachined ultrasonic transducer are micro-ultrasonic transducers manufactured by using a MEMS process. For the capacitive micromachined ultrasonic transducer, a cavity is usually formed on a silicon substrate, a top surface of the cavity is made of a diaphragm material, for example, nitride, and a signal is applied by using an electrode material, to implement ultrasonic wave emission. For the piezoelectric micromachined ultrasonic transducer, a piezoelectric material, for example, lead zirconate titanate piezoelectric ceramics, is usually stacked on a silicon substrate. Similarly, after a signal is applied through an electrode, an ultrasonic wave is generated due to a converse piezoelectric effect. The two types of ultrasonic transducers based on the MEMS process can be conveniently designed in an array. This helps increase a sound pressure level of an initial ultrasonic wave formed by the vibration member, thereby increasing a sound pressure level of a modulated ultrasonic wave formed by the sound generation apparatus 100. Therefore, a sound pressure level of an audible sound is high.

It may be understood that in addition to the foregoing embodiments, the ultrasonic transducer may have another implementation structure. This is not strictly limited in this embodiment of this application.

It may be understood that embodiments of this application and features in embodiments may be combined with each other if there is no conflict, and any combination of features in different embodiments also falls within the protection scope of this application. In other words, the plurality of embodiments described above may be further randomly combined based on an actual requirement.

It may be understood that all the foregoing accompanying drawings are example illustrations of this application, and do not represent actual sizes of products. In addition, a dimension proportion relationship between parts in the accompanying drawings is not intended to limit an actual product in this application.

The foregoing descriptions are merely specific implementations of this application, but are not intended to limit the protection scope of this application. Any variation or replacement readily figured out by a person skilled in the art within the technical scope disclosed in this application shall fall within the protection scope of this application. If there is no conflict, embodiments of this application and the features in embodiments may be combined with each other. Therefore, the protection scope of this application shall be subject to the protection scope of the claims.

1. An electronic device, comprising:
a sound generation apparatus comprising:
a transducer comprising a vibration member;
a driving apparatus coupled to the transducer; and
a control circuit electrically coupled to the transducer and the driving apparatus and configured to:
drive the vibration member to vibrate; and
control the driving apparatus to drive the transducer to perform a periodic motion.

2. The electronic device of claim 1, wherein the control circuit is further configured to control the driving apparatus to drive the transducer to perform continuous rotation, reciprocating rotation, or reciprocating translational motion.

3. The electronic device of claim 2, wherein the transducer further comprises a rotating shaft, and wherein, when the transducer performs continuous rotation or reciprocating rotation, the rotating shaft deviates from a center of the transducer and is parallel to a plane on which the transducer is located, intersects with the transducer, or is perpendicular to the transducer.

4. The electronic device of claim 1, wherein the sound generation apparatus further comprises a base comprising a first side and a second side, wherein the transducer is disposed on the base, wherein the driving apparatus comprises:
a first cantilever comprising a first movable end coupled to the first side; and
a second cantilever comprising a second movable end coupled to the second side,
wherein the control circuit is further configured to drive the first movable end and the second movable end to perform reciprocating vibration, and
wherein, in a same time period, vibration directions of the first movable end and the second movable end are opposite.

5. The electronic device of claim 4, wherein the base has a rotation angle (θ), and wherein θ satisfies: −45°≤θ≤45°.

6. The electronic device of claim 1, wherein the sound generation apparatus further comprises a base, wherein the transducer is disposed on the base, wherein the driving apparatus comprises a first motor, and wherein the first motor comprises a first output shaft coupled to the base and configured to drive the base to perform reciprocating rotation or continuous rotation.

7. The electronic device of claim 6, wherein the sound generation apparatus further comprises a plurality of transducers arranged on the base at an interval in a rotation direction.

8. The electronic device of claim 1, wherein the sound generation apparatus further comprises a base, wherein the transducer is disposed on the base, and wherein the driving apparatus comprises a telescopic arm coupled to the base and configured to extend and retract to drive the base to perform reciprocating translational motion.

9. The electronic device of claim 1, wherein the control circuit is further configured to:
generate a first control signal configured to drive the vibration member to vibrate for generating a first sound wave; and
generate a second control signal configured to control the driving apparatus to drive the transducer in a periodic motion to modulate the first sound wave to generate a second sound wave.

10. The electronic device of claim 9, wherein the first control signal comprises a first frequency (f₁), wherein f₁ is a first single frequency or a first wideband frequency, wherein the second control signal comprises a second frequency (f₂), and wherein f₂ is a second single frequency or a second wideband frequency.

11. The electronic device of claim 10, wherein the second sound wave comprises an audible sound, and wherein f₁ and f₂ satisfy: 20 Hz≤|f₁−f₂|≤20 KHz.

12. The electronic device of claim 10, wherein the second sound wave comprises a third frequency, and wherein the third frequency is |f₁−f₂| and |f₁+f₂|.

13. The electronic device of claim 12, wherein f₁ and f₂ further satisfy: f₁≥20 and f₂≥20 KHz.

14. The electronic device of claim 12, wherein f₁ and f₂ further satisfy: |f₁+f₂|≥ 20 KHz.

15. The electronic device of claim 9, wherein the vibration member comprises a vibration frequency, wherein the vibration frequency comprises a first frequency (f₁), wherein f₁ is a first single frequency or a first wideband frequency, wherein the transducer comprises a motion frequency, wherein the motion frequency comprises a second frequency (f₂), wherein f₂ is a second single frequency or a second wideband frequency, wherein the second sound wave comprises a third frequency, wherein the third frequency comprises |f₁−f₂| and |f₁+f₂|, wherein at least a part of the second sound wave comprises an audible sound, and wherein f₁ and f₂ satisfy: 20 Hz≤|f₁−f₂|≤20 KHz.

16. The electronic device of claim 1, wherein the sound generation apparatus further comprises a casing, and wherein the casing comprises:
an inner cavity, wherein both the transducer and the driving apparatus are disposed in the inner cavity;
an external space, wherein the control circuit is disposed in the inner cavity or the external space; and
a sound outlet hole that communicates with the inner cavity and the external space.

17. The electronic device of claim 16, wherein the sound outlet hole comprises an extension direction, wherein there is an included angle (a) between an axial direction of the vibration member and the sound outlet hole, and wherein a satisfies: 45°% a≤135°.

18. The electronic device of claim 16, wherein the casing comprises an inner surface, and wherein the sound generation apparatus further comprises a sound-absorbing part disposed on the inner surface and arranged in a staggered manner with the sound outlet hole.

19. The electronic device of claim 16, wherein the casing further comprises a sound wave guiding structure disposed at an interval from the sound outlet hole and communicating the inner cavity with the external space.

20. The electronic device of claim 19, wherein the sound wave guiding structure is a hole structure and/or a pipe structure, wherein a minimum width of the sound wave guiding structure is greater than a thickness (du) of a viscous layer, wherein d_{μ} satisfies:
$${d}_{μ} = 0.22 mm \times \sqrt{\frac{100 Hz}{{f}_{1}}} ,$$
and
wherein f₁ is a frequency of a first sound wave.
